(19) United States
(12) Patent Application Publication
(10) Pub. No.: US 2015/0281853 A1
(43) Pub. Date: Oct. 1, 2015

(54) SYSTEMS AND METHODS FOR ENHANCING TARGETED AUDIBILITY

(71) Applicant: SoundFest, Inc., Framingham, MA (US)

(72) Inventors: Mark Eisner, Framingham, MA (US); Zezhen Huang, Canton, MA (US); David Duehren, Needham, MA (US)

(21) Appl. No.: 14/561,026

(22) Filed: Dec. 4, 2014

Related U.S. Application Data
(63) Continuation-in-part of application No. 14/292,398, filed on May 30, 2014, now abandoned.
Application No. 14/292,398 is a continuation-in-part of application No. 13/546,465, filed on Jul. 11, 2012, now abandoned.
(60) Provisional application No. 61/829,242, filed on May 30, 2013.
(60) Provisional application No. 61/603,633, filed on Feb. 27, 2012.
(60) Provisional application No. 61/522,919, filed on Aug. 12, 2011.
(60) Provisional application No. 61/506,354, filed on Jul. 11, 2011.

(51) Int. Cl. H04R 25/00

(52) U.S. Cl. CPC H04R 25/30

(57) ABSTRACT

Systems and methods disclosed herein provide for low cost hearing assistance to improve intelligible hearing for those with normal hearing and to greatly improve hearing intelligibility for those with hearing problems. One goal of the systems and methods disclosed herein is to make hearing assistance algorithms easily accessible and available by implementing such algorithms using non-dedicated hardware platforms such as non-dedicated mobile computing devices, e.g., smartphones, PDA's and the like. In exemplary embodiments, the systems and method of the present disclosure integrate hearing assistance algorithms with multi-media algorithms in an API stack (similar to the implementation of audio effects such as stereo widening and psychoacoustic bass enhancement) thereby addressing processing delay concerns.

### CROSS-REFERENCE TO RELATED APPLICATION

This application is a continuation-in-part (CIP) application of U.S. patent application Ser. No. 14/292,398, filed May 30, 2014 which claims priority to U.S. Provisional Patent Application Ser. No. 61/829,242, filed May 30, 2013, and is a continuation-in-part of U.S. patent application Ser. No. 13/546,465, filed Feb. 27, 2012, which claims priority to U.S. Provisional Patent Application Ser. No. 61/603,633, filed Feb. 27, 2012, and U.S. Provisional Patent Application Ser. No. 61/522,919, filed Aug. 12, 2011 and U.S. Provisional Patent Application Ser. No. 61/506,354, filed Jul. 11, 2011, the contents of each of the forgoing applications being incorporated herein by reference in their entirety.

### BACKGROUND

Speech intelligibility can often be a problem for people even with slight to moderate hearing loss. Even listeners with normal hearing may have difficulty understanding speech in a very noisy environment. Conventional hearing assistance products such as hearing aids and personal amplifiers are often limited in their ability to detect speech and speech clarity can suffer as a result. Indeed, dedicated hardware requirements of conventional hearing assistance devices make it extremely difficult to incorporate complex processor heavy speech detection algorithms in a cost effective manner. Thus, conventional hearing assistance products may often amplify non-speech background noise such as street traffic noise, wind noise, car engine noise, background music/TV noise and the like. Such unwanted amplification of non-speech background noise can be both annoying and distracting.

Existing hearing assistance implementations for non-dedicated hardware platforms, such as smart phone applications, typically provide only basic functionality that falls short. One reason for this limited functionality is because of operating system limitations. In particular, operating systems in typical non-dedicated mobile computing devices may not provide adequate “real-time” runtime environments, e.g., for digital signal processing. For example, operating systems, such as android, which rely heavily on virtualization to run across multiple hardware platforms may exhibit greater operating system latency, e.g., on account of the added virtualization engine layer. Another common problem with conventional hearing assistance implementations for non-dedicated hardware platforms is the inefficient use of hardware resources in signal processing, including, for example, in implementation of analog-to-digital signal conversion, digital-to-analog signal conversion, and/or digital signal processing. In particular, existing hearing assistance implementations for non-dedicate hardware platforms lack optimization for streamlining signal processing to reduce processing latency. Finally, conventional hearing assistance implementations for non-dedicated hardware platforms typically fail to address/consider communication latency, e.g., between a computing device and an external microphone and/or speaker.

The aggregate effects of operating system latency, processing latency and/or communication latency in conventional implementations consequently often severely hampers the level of signal processing that is achievable without resulting in an excessive total (analog sound in to analog sound out) latency (for example, greater than 40 ms). Notably, processing delays of greater than 40 ms may result in a perceivable echo between perception of raw unprocessed sounds relative to the corresponding processed signal. For existing hearing assistance applications running on non-dedicated mobile computing devices even the most basic signal processing algorithms typically run with too much delay; putting the use of more sophisticated noise suppression algorithms well out of reach. While noise isolation may help reduce the echo effect by isolating the user from any raw unprocessed sounds, the user may still perceive a visual delay (e.g., between lip movement versus perceived sound). Moreover, complete noise isolation is often undesirable in every day interactions.

Hearing loss is a global problem, with nearly 700 million people suffering from hearing problems, and the rate of hearing loss accelerating around the world. As many as 47 million Americans currently suffer hearing loss in one or both ears. As the U.S. population ages, hearing loss is growing at 160% the rate of population growth. Hearing loss is now considered an emerging public health issue. In the U.S. 75% to 80% of those suffering hearing-loss do not have a hearing aid.

Some of the primary barriers to wider adoption of hearing aids for those with slight to moderate/severe hearing loss are high cost, stigma, the need for an audiologist's involvement to make complex adjustments, and processing limitations including a lack of speech clarity, feedback loop problems, and noise. Cost may be the single biggest problem across market segments; for those with slight-to-moderate hearing loss. Adequately performing hearing aids, or other hearing assistance products using a conventional dedicated hardware platform, can often cost thousands of dollars and as such do not present a viable value proposition. The physically tight space in which hearing aid digital signal processing is done, make hearing aid components expensive. Also the design of these components is made more expensive by feedback issues because of the close proximity of the microphone and the speaker. Furthermore, hearing aids are generally not covered by insurance. On the other side of the spectrum, low cost alternatives such as Personal Sound Amplification products (PSAPs) typically fail to provide sufficient processing power and features to afford practical solutions for everyday situations.

### SUMMARY

Systems and methods disclosed herein provide for low cost hearing assistance to improve intelligible hearing for those with normal hearing and to greatly improve hearing intelligibility for those with hearing problems. One goal of the systems and methods disclosed herein is to make hearing assistance algorithms easily accessible and available by implementing such algorithms using non-dedicated hardware platforms such as non-dedicated mobile computing devices, e.g., smartphones, PDA's and the like. In exemplary embodiments, the systems and method of the present disclosure integrate hearing assistance algorithms with multi-media algorithms in an API stack (similar to the implementation of audio effects such as stereo widening and psychoacoustic bass enhancement) thereby addressing processing delay concerns.

As noted above, the systems and methods of the present disclosure may utilize a non-dedicated hardware platform, such as a non-dedicated computing device, e.g., running a multipurpose programmable processor and standard operating system. In exemplary embodiments, the non-dedicated computing device may be a mobile device such as a smartphone, tablet, PDA, or other mobile device. Examples, of existing standard operating systems running on mobile devices include, for example, Android based operating systems, iOS based operating systems, Windows based operating systems, Blackberry based operating systems, Linux/Unix based operating systems, and the like. Standard operating systems may typically be characterized by the ability to access, load and run software applications (such as third-party developed applications) which are stored in memory (e.g., using a non-transient storage medium). Multipurpose programmable operating systems may typically be associated with software development kits (SDKs or “devkits”) implementing one or more application programming interfaces (APIs) and/or event oriented callbacks thereby enabling the creation of such software applications. Advantageously, a large segment of the population already owns and/or regularly utilizes non-dedicated mobile computing devices with powerful multipurpose programmable central processing units (CPUs) and standard operating systems, that can accommodate software applications. Thus, the systems and methods of the present disclosure reduce cost by utilizing such multipurpose programmable CPUs and standard operating systems, thereby reducing the need for expensive dedicated and proprietary hardware.

Advantageously, typical non-dedicated mobile computing devices often include analog-to-digital converters (ADCs) which can convert an analog signal (e.g., from a microphone) into a digital signal (e.g., for digital signal processing) and digital-to-analog-converters (DACs) which can convert a digital signal (e.g., a processed digital signal) into an analog signal (e.g., to drive a speaker). In exemplary embodiments, systems and methods of the present disclosure may configure (e.g., optimize) the operation of one or more of the ADC, digital signal processing (DSP), DAC and/or any interface communication adapters (for example, between the microphone and a processing unit and/or between a processing unit and the earpiece) so as to minimize latency. For example, in some embodiments, the systems and methods of the present disclosure may utilize sampling rates and buffers in analog-to-digital conversion and/or digital-to-analog conversion which reduce processing latency.

In exemplary embodiments, interface communication adapters may include wireless communication adapters for implementing wireless communications (e.g., Bluetooth, Wi-Fi, and the like). Thus, in some embodiments, the systems and methods of the present disclosure may implement wireless communication protocols, e.g., such as novel Bluetooth communication protocols disclosed herein, which utilize reduced error checking and/or buffering, so as to reduce communication related latency.

In further exemplary embodiments, operating system latency may be reduced by reducing or eliminating virtualization, e.g., with respect to various signal processing. For example, in some embodiments, the virtualization layer may be optimized or even eliminated to reduce operating system latency. In example embodiments, a supplemental DSP API stack (e.g., implementing an audio digital services layer (DSL)) such as one characterized by thin virtualization layer or with direct hardware integration, may be used in conjunction with the existing operating system API layer, to reduce operating system latency. In Android and other Unix/Linux based operating systems this may involve, e.g., making use of a Java Native Interface (JNI) of the operating system to wrap libraries, to include the DSP API layer, thereby enabling a faster DSP runtime environment, e.g., optimized for the particular hardware/chipset.

In exemplary embodiments, the systems and methods of the present disclosure may manage the aggregate impact of processing latency, operating system latency, and/or communications latency, so as to achieve a total (analog sound in to analog sound out) latency that reduces/eliminates the perceptibility of a time delay echo, for example, a total latency of less than 40 ms and in some embodiments less than 20 ms.

Additional features of the systems and methods disclosed are described in the detailed description sections which follow. Having described, herein, various exemplary embodiments of the disclosure, it is to be appreciated various alterations, modifications, and improvements will readily occur to those skilled in the art. Accordingly, the present description and drawings are by way of example only. In addition it is appreciated that exemplary embodiments presented herein do not limit the scope of the subject application.

### BRIEF DESCRIPTION OF DRAWINGS

FIG. 1 depicts a block diagram of an exemplary non-dedicated mobile computing device that may be used to implement exemplary embodiments described herein, according to the present disclosure.

FIG. 2 depicts a block diagram of an exemplary network environment suitable for a distributed implementation of exemplary embodiments described herein, according to the present disclosure.

FIG. 3 depicts an exemplary method for providing targeted audibility, according to the present disclosure.

FIG. 4 illustrates exemplary components which may contribute to aggregate latency, according to the present disclosure.

FIG. 5 depicts an exemplary DSP process using a primary processing thread, according to the present disclosure.

FIGS. 6A-6S illustrate an exemplary user interface for an application which may be used in conjunction with embodiments disclosed herein to increase the audibility of targeted speech, according to the present disclosure.

FIG. 7 depicts a block diagram for an exemplary application which may be used in conjunction with embodiments disclosed herein to increase the audibility of targeted speech, according to the present disclosure.

FIG. 8 depicts an exemplary set of DSP algorithms for an exemplary application which may be used in conjunction with embodiments disclosed herein to increase the audibility of targeted speech, according to the present disclosure.

FIG. 9 depicts an exemplary speech enhancement algorithm according to the present disclosure.

### DETAILED DESCRIPTION

Systems and methods disclosed herein provide for low cost hearing assistance to improve intelligible hearing for those with normal hearing and to greatly improve hearing intelligibility for those with hearing problems.

Sound Signal: as used herein, sound signal is synonymous with audio signal and is used to refer generally to any signal, for example, any electronic transmission, which may be used to transmit or otherwise represent sound, for example, audible sound, whether in digital or analog form.

Speech: As used herein, speech may generally refer to any type of communicative sound which may be of potential interest to a user. In some embodiments, speech may refer to a particular type of communicative sound signal, for example, spoken dialogue or the like.

Targeted Speech: As used herein, targeted speech may refer to speech originating from a desired/targeted source or sources and/or otherwise meeting a predetermined set of criteria (for example, dialogue from a person or people of interest, dialogue from a TV or radio program, or the like).

Targeted Audio: As used herein, targeted audio, also referred to as targeted sound or as a targeted portion of ambient sound, may refer to sound originating from a desired/targeted source or sources and/or otherwise meeting a predetermined set of criteria. In some embodiments, targeted audio may be speech, for example targeted speech, or speech in general.

Ambient Sound: As used herein, ambient sound may refer to sound as perceivable in a particular environment/location, such as sound that is perceivable by a user or by a microphone in proximity to the user and/or in proximity to a non-dedicated mobile computing device operatively associated with the microphone. In some embodiments, ambient sound may be used to estimate a noise profile, for example, by recording ambient sound during an absence of targeted audio, for example, an absence of targeted speech or an absence of speech in general.

Noise: As used herein, noise, may generally refer to any sound signal or component thereof that is not targeted audio. In some embodiments, a noise profile may be estimated, for example, based on ambient sound recorded during an absence of targeted audio, for example, an absence of targeted speech or an absence of speech in general.

Audibility: As used herein, audibility may refer to a degree to which a sound can be heard, discerned and/or comprehended, e.g., by a user.

Non-Dedicated Mobile Hardware Platform: As used herein, a non-dedicated mobile hardware platform may refer to any mobile hardware platform which does not have a dedicated or primary purpose as a hearing assistance product. In general, a non-dedicated mobile hardware platform may be a non-dedicated mobile computing device which includes a multipurpose programmable processor, runs a standard operating system, and is designed to be portable or semi-portable.

Multipurpose programmable Processor: As used herein, a multipurpose programmable processor or multipurpose programmable central processing unit (CPU) may refer to a processor that is not configured for the specific purpose/implementation of providing hearing assistance but rather is adaptable for other purposes/implementations. Thus, a multipurpose programmable processor is explicitly distinguished from proprietary chipsets found in dedicated hearing assistance products which are specifically configured for processing an audio signal to provide hearing assistance. In example embodiments, a multipurpose programmable processor may be characterized by a general instruction set, e.g., from which a specific algorithm may be derived for a given purpose/implantation such as processing of an audio signal to provide hearing assistance. A multipurpose programmable processor, is typically configured to enable execution of a wide range of applications. In some embodiments, the multipurpose programmable processor may be a low power consumption multipurpose programmable processor. In example embodiments, the multipurpose programmable processor may include one or more sub/co-processors for implementing specific functionalities as part of the general instruction set available, e.g., for implementing signal processing functionalities such as analog-to-digital conversion, digital-to-analog conversion, specific types of digital signal processing and/or the like. Examples of multipurpose programmable processors include ARM Cortex-A9, Samsung S5PC100, and TIOMAP4 Platform, Apple A4 and the like.

Standard Operating System: As used herein, a standard operating system may refer to an operating system, operatively capable of accessing, loading and running a software application, e.g., a third-party application. In general, a standard operating system is software that manages hardware and software resources and provides as set of common services for executing applications. Applications may make use of the standard operating system by making requests for services through a set of predefined multipurpose programmable APIs. Typically, APIs for a standard operating system may be included in an SDK thereby enabling developers to develop new applications to run on the standard operating system. Examples of a standard operating systems include Microsoft Windows mobile operating systems (Windows RT), UNIX and Linux operating systems (e.g., Android), iOS operating systems, or any other multipurpose programmable operating system capable of running on a non-dedicated mobile computing device and performing the operations described herein.

Kernel: As used herein, kernel may be used to refer to a central component of a standard operating system which bridges between applications and data processing at the hardware level.

Speaker: As used herein, a speaker may refer to any device which translates an analog audio signal into sound.

User: As used herein, a user may refer to an entity that is using an embodiment of the invention.

In exemplary embodiments, systems and methods are presented which utilize a non-dedicated mobile hardware platform to process ambient sound and enhance the audibility of a targeted portion of the ambient sound, for example, to enhance speech. As noted above, a non-dedicated mobile hardware platform may refer to any mobile hardware platform which does not have a dedicated or primary purpose as a hearing assistance product. In exemplary embodiments, the non-dedicated mobile hardware platform may be a non-dedicated mobile computing device which includes a multipurpose programmable processor, runs a standard operating system, and is configured/adapted to be portable or semi-portable. Examples of non-dedicated mobile computing devices, for example, smartphones, tablets, laptops, PDAs, media players, such as mp3 players, and the like.

In exemplary embodiments, the non-dedicated mobile computing device may include or otherwise be operatively associated with a sensor for detecting ambient sound, such as a microphone. The microphone may either be an integral component (for example, internal to the computing device) or an external component (for example, operatively associated with the computing device via a wired or wireless connection).

In exemplary embodiments, the non-dedicated mobile computing device may include or otherwise be operatively associated with a speaker for outputting sound processed for targeted audibility, for example a headset, earphones and the like. In some embodiment, a same external component, for example a headset, may include both a speaker and a microphone.

As noted above, the non-dedicated mobile computing device may also include a ADC and DAC components, networking or other communication components, e.g., wireless communication components, memory, e.g., for storing one or more applications and user interface components such as a display, touch interface, pointing device, keypad and the like.

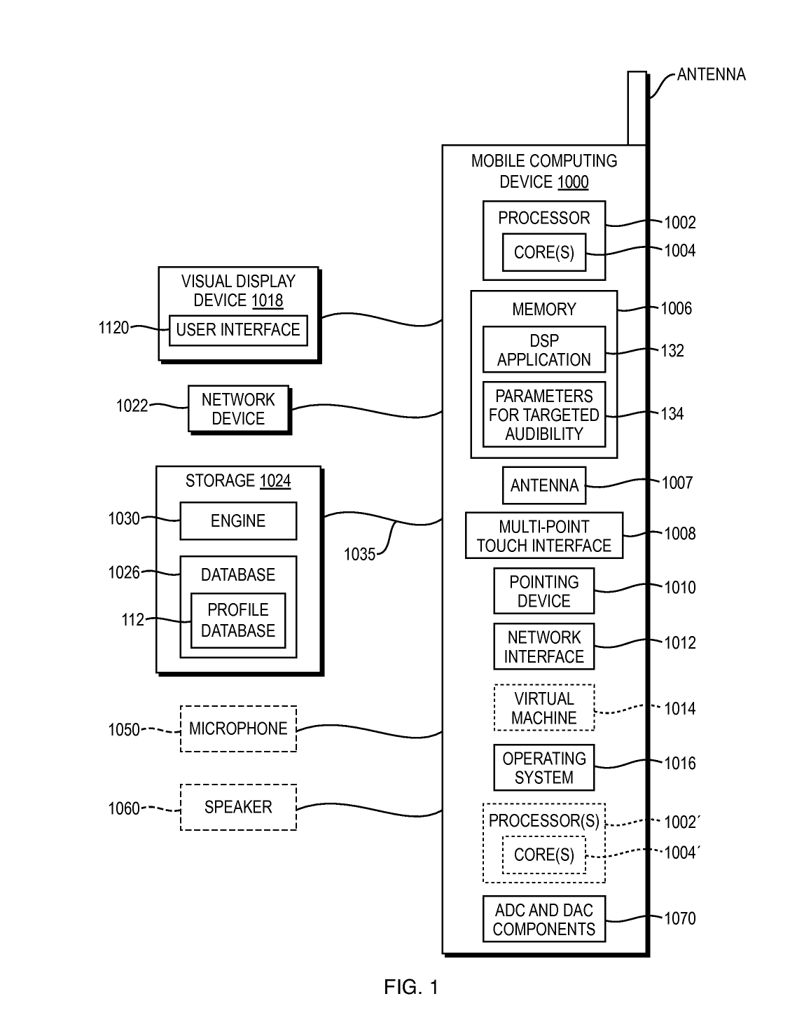

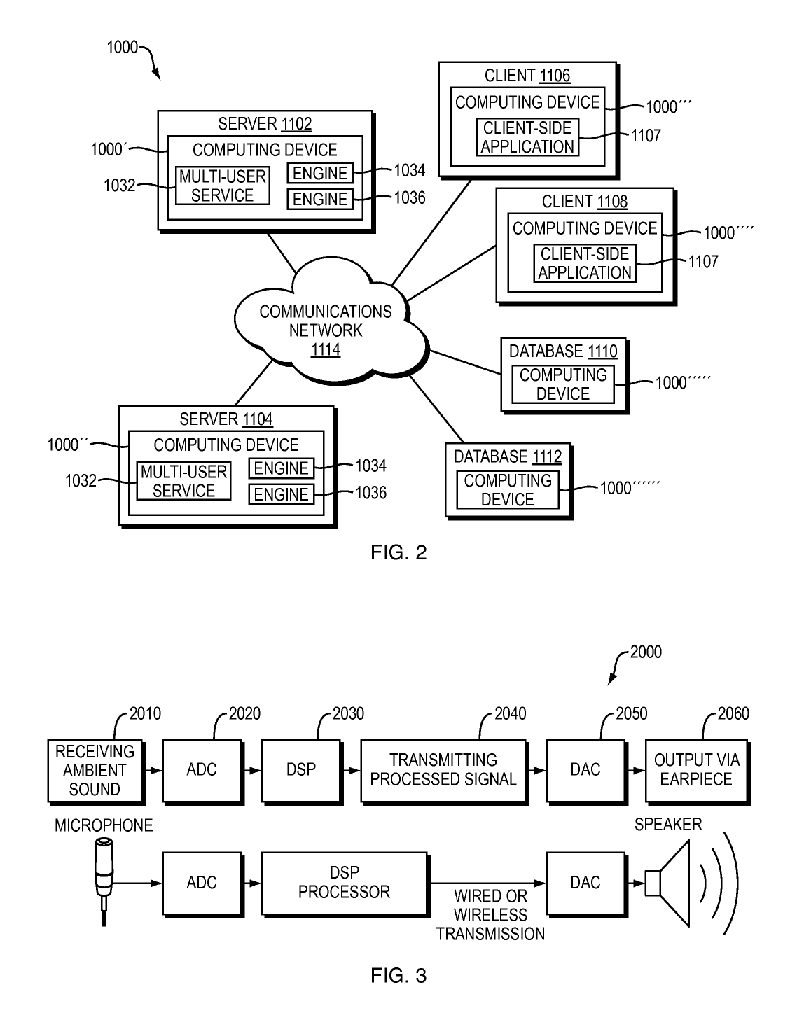

FIG. 1 is a block diagram of an exemplary non-dedicated mobile computing device 1000 that may be used to implement exemplary embodiments described herein. The mobile computing device 1000 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 1006 included in the computing device 1000 may store non-transitory computer-readable and computer-executable instructions or software for implementing exemplary embodiments, such as a low latency process for using DSP to enhance targeted audibility, for example, of speech, in ambient sound, such as the process 2000 of FIG. 3. Thus, memory 1006 may include, for example, a DSP application 132 as well as one or more parameters for setting the targeted audibility 134. The computing device 1000 may also include an antenna 1007, for example, for wireless communication with external components, such as a microphone 1050 or speaker 1060 and/or with other computing devices, e.g., via the network of FIG. 2. In some embodiments, the microphone 150 and/or speaker 160 may be internal to the mobile computing device. The computing device 1000 also includes a multipurpose programmable processor 1002 which may have an associated core (kernel) 1004, and optionally, one or more additional processor(s) 1002′ and associated core(s) 1004′ (for example, in the case of mobile computer systems having multiple processors/cores), for executing non-transitory computer-readable and computer-executable instructions or software stored in the memory 1006 and other programs for controlling system hardware. Processor 1002 and processor(s) 1002′ may each be a single core processor or multiple core (1004 and 1004′) processor.

In exemplary embodiments, virtualization may be employed in the computing device 1000, e.g., so as to facilitate cross platform OS integration (e.g., in the case of cross-platform virtualization) and/or to enable dynamically sharing of resources in the computing device. Thus, a virtual machine 1014 may be provided to handle a process running in a virtual environment. Multiple virtual machines may also be used with one processor. Notably, one of the feature of the systems and methods of the present disclosure is to optimize, e.g., minimize, reduce or eliminate, virtualization with respect to signal processing.

Memory 1006 may include a computer system memory or random access memory, such as DRAM, SRAM, EDO RAM, and the like. Memory 1006 may include other types of memory as well, or combinations thereof.

A user may interact with the computing device 1000 through a visual display device 1018, such as a computer monitor or touch screen display integrated into the computing device 1000, which may display one or more user interfaces 1020 that may be provided in accordance with exemplary embodiments. The computing device 1000 may include other I/O devices for receiving input from a user, for example, oneboard or any suitable multi-point touch interface 1008, a pointing device 1010 (for example, a mouse). The keypad 1008 and the pointing device 1010 may be coupled to the visual display device 1018. The computing device 1000 may include other suitable conventional I/O peripherals.

The computing device 1000 may also include one or more storage devices 1024, such as a hard-drive, CD-ROM, or other non-transitory computer-readable media, for storing data and non-transitory computer-readable instructions and/or software that implement exemplary embodiments described herein. The storage devices 1024 may be integrated with the computing device 1000. The computing device 1000 may communicate with the one or more storage devices 1024 via a bus 1035. The bus 1035 may include parallel and/or bit serial connections, and may be wired in either a multi-drop (electrical parallel) or daisy-chain topology, or connected by switched hubs, as in the case of USB. Exemplary storage device 1024 may also store one or more databases 1026 for storing any suitable information required to implement exemplary embodiments. For example, exemplary storage device 1024 can store one or more databases 1026, including a profile database 112, for profiling parameters relating to a user's hearing, ambient noise, audibility preferences, targeted sound types and the like inventory database. The storage device 1024 can also store an engine 1030 including logic and programming for receiving the user input parameters and outputting one or more recommended items based on the input parameters, for performing one or more of the exemplary methods disclosed herein.

The mobile computing device 1000 can include a network interface 1012 configured to interface via one or more network devices 1022 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections (e.g., Bluetooth), controller area network (CAN), or some combination of any or all of the above. The network interface 1012 may include a built-in network adapter, network interface card, PCMCIA network card, card bus network adapter, wireless network adapter, USB network adapter, modem or any other device suitable for interfacing the computing device 1000 to any type of network capable of communication and performing the operations described herein. Moreover, the mobile computing device 1000 may be any computer system that has sufficient processor power and memory capacity to perform the operations described herein.

The mobile computing device 1000 may run any standard operating system 1016, such as any of the versions of the Microsoft Windows mobile operating systems (Windows RT), different releases of the Unix and Linux operating systems (e.g., Android), any version of the iOS, or any other non-proprietary operating system capable of running on the computing device and performing the operations described herein. In exemplary embodiments, the operating system 1016 may be run in native mode or emulated mode. In some embodiments, the operating system may include a supplemental DSP API stack (e.g., implementing an audio digital services layer (DSL)) such as one characterized by thin virtualization layer or with direct hardware integration. The DSP API stack may be integrated and used in conjunction with the standard operating system API layer, e.g., to facilitate reducing operating system latency.

The, mobile computing device 1000 may also typically include ADC and DAC components 1070.

FIG. 2 is a block diagram of an exemplary network environment 1100 suitable for a distributed implementation of exemplary embodiments. The network environment 1100 may include one or more servers 1102 and 1104, one or more clients 1106 and 1108, and one or more databases 1110 and 1112, each of which can be communicatively coupled via a communication network 1114, such as the network 120 of FIG. 1. The servers 1102 and 1104 may take the form of or include one or more computing devices 1000′ and 1000″, respectively. The clients 1106 and 1108 may take the form of or include one or more computing devices 1000′″ and 1000″″, respectively, that are similar to the non-dedicated mobile computing device 1000 illustrated in FIG. 1. Similarly, the databases 1110 and 1112 may take the form of or include one or more computing devices 1000′″″ and 1000″″″. While databases 1110 and 1112 have been illustrated as devices that are separate from the servers 1102 and 1104, those skilled in the art will recognize that the databases 1110 and/or 1112 may be integrated with the servers 1102 and/or 1104 and/or the clients 1106 and 1108.

The network interface 1012 and the network device 1022 of the computing device 1000 enable the servers 1102 and 1104 to communicate with the clients 1106 and 1108 via the communication network 1114. The communication network 1114 may include, but is not limited to, the Internet, an intranet, a LAN (Local Area Network), a WAN (Wide Area Network), a MAN (Metropolitan Area Network), a wireless network, an optical network, and the like. The communication facilities provided by the communication network 1114 are capable of supporting distributed implementations of exemplary embodiments.

In exemplary embodiments, one or more client-side applications 1107 may be installed on client 1106 and/or 1108 to allow users of client 1106 and/or 1108 to access and interact with a multi-user service 1032 installed on the servers 1102 and/or 1104. For example, the users of client 1106 and/or 1108 may include users associated with an authorized user group and authorized to access and interact with the multi-user service 1032. In some embodiments, the servers 1102 and 1104 may provide client 1106 and/or 1108 with the client-side applications 1107 under a particular condition, such as a license or use agreement. In some embodiments, client 1106 and/or 1108 may obtain the client-side applications 1107 independent of the servers 1102 and 1104. The client-side application 1107 can be computer-readable and/or computer-executable components or products, such as computer-readable and/or computer-executable components or products for presenting a user interface for a multi-user service. One example of a client-side application is a web browser that allows a user to navigate to one or more web pages hosted by the server 1102 and/or the server 1104, which may provide access to the multi-user service.

The databases 1110 and 1112 can store user information, profile data and/or any other information suitable for use by the multi-user service 1032. The servers 1102 and 1104 can be programmed to generate queries for the databases 1110 and 1112 and to receive responses to the queries, which may include information stored by the databases 1110 and 1112, e.g., audio profiling information.

FIG. 3 depicts an exemplary embodiment, of a method 2000 for providing targeted audibility, for example of speech, which may be implemented using a mobile device such as the non-dedicated mobile computing device 1000 of FIG. 1. Method 2000 generally including steps of 2010 receiving on a mobile computing device, for example, via an internal or external microphone, ambient sound; 2020 converting the ambient sound to a digital audio signal using an ADC; 2030 preforming digital signal processing using the mobile computing device to process the digital audio signal and enhance the audibility of a targeted portion of the ambient sound; 2040 transmitting, through a wired or wireless connection, the processed digital audio signal to a listener's earpiece; 2050 converting the processed digital audio signal to an analog signal; and 2060 converting the processed signal to sound using e.g., the speaker of an earpiece. In some embodiments, the mobile computing device may convert the processed digital audio signal to an analog signal prior to transmitting the analog signal to the speaker, e.g., via a wired or wireless connection (e.g. steps 2040 and 2050 may be reversed).

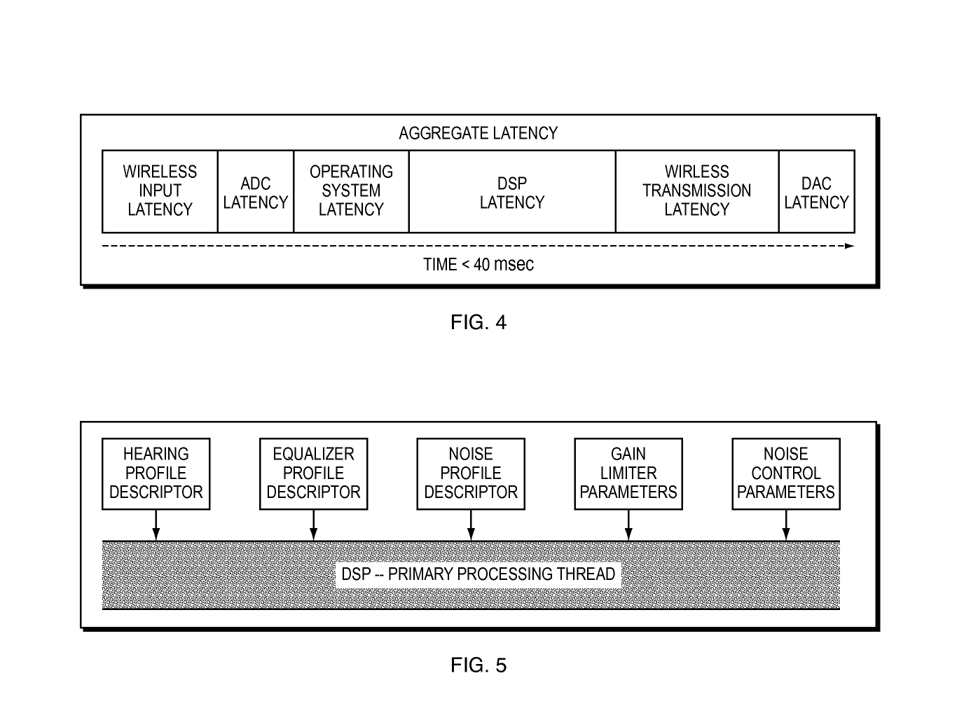

As depicted in FIG. 4, in exemplary embodiments, the aggregate (total) latency including any wireless input latency, ADC latency, operating system latency, DSP latency, wireless transmission latency, and DAC latency is sufficiently low such that a user will not perceive an echo-like delay between the processed sound exiting from the speaker and the raw sound entering the ear. In exemplary embodiments, the total aggregate latency is less than 40 ms. In further exemplary embodiments, the total aggregate latency is less than 25 ms. In some embodiments, the total aggregate latency is less than 20 ms. In example embodiments, signal processing contributions to the aggregate delay, which may include, e.g., ADC latency, operating system latency, DSP latency and DAC latency, may be less than 25 ms.

In exemplary embodiments, the aggregate latency may be reduced by performing DSP such that DSP latency is less than 15 ms. In some embodiments DSP latency is less than 10 ms. In yet further embodiments, DSP latency is less than 5 ms. In exemplary embodiments, DSP is executed in near-real-time or using the highest priority thread of the CPU. DSP is generally executed using parameters calculated on a separate thread and/or using a predetermined set of parameters so as to avoid having to calculate or otherwise determine parameters in on the highest priority thread. The parameters may be provided/modified, via user input and/or automatic calculations which are processed, for example, in parallel with DSP using lower priority threads. Parameters may include a profile indicator for ambient noise, a profile indicator for a user's hearing, a profile indicator for user sound preferences (e.g., an equalizer setting,), gain parameters, noise, control parameters, and the like.

FIG. 5 depicts an exemplary DSP process using a primary processing thread. Input parameters include a hearing profile descriptor, equalizer profile descriptor, noise profile descriptor, gain parameters, including gain limiter parameters (e.g., to maintain safe decibel levels) and noise control parameters. Input parameters are generally predetermined, for example, via user input, and/or parallel processes. The DSP process and related parameters are discussed in greater detail in the description which follows. DSP may include, for example, gain control gain shaping, frequency gain adjustment, frequency mapping, dynamic range compression, noise suppression/removal, speech detection, speech enhancement (sharper constants etc), detection and suppression of non-speech impulse sound, and the like.

In exemplary embodiments, the input buffer for the ADC, e.g., the analog signal sampling rate for the input buffer is optimized such that the ADC latency is less than 10 ms. Similarly, in exemplary embodiment, the input buffer for the DAC, is optimized such that the DAC latency is less than 10 ms.

Exemplary User Interface:

Mobile computing devices may display digital content and controls to Users through an intuitive User Interface (UI) displayed as discrete screens. The UI may include, for example, various windows, tabs, icons, menus, sub-menus, and touch screen controls such as radio buttons, check boxes, slider bars, etc.

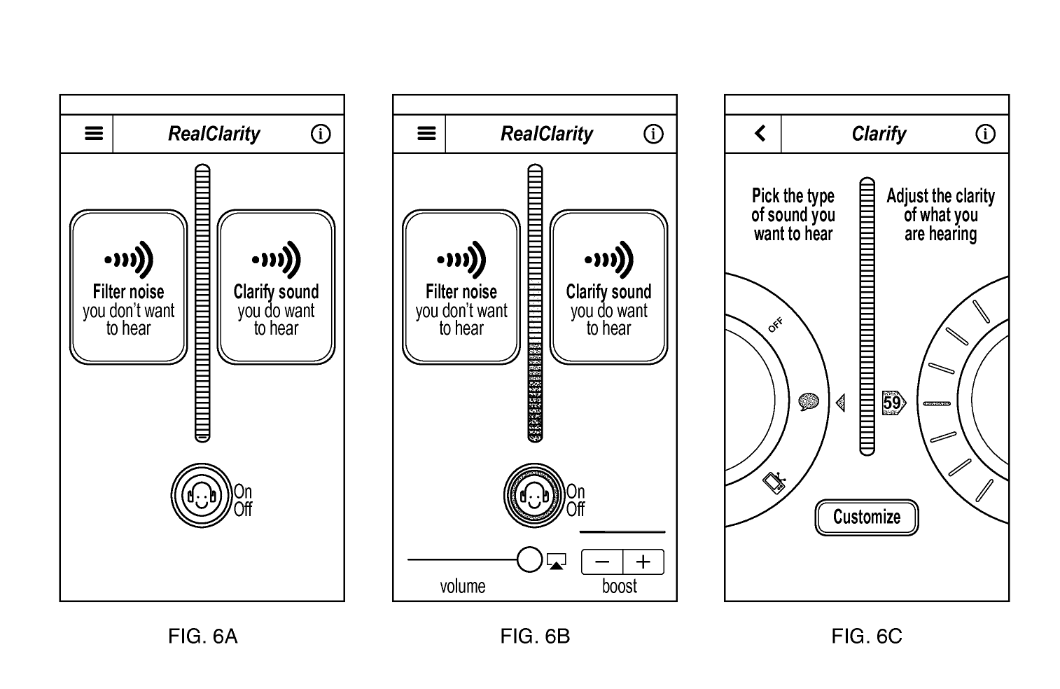

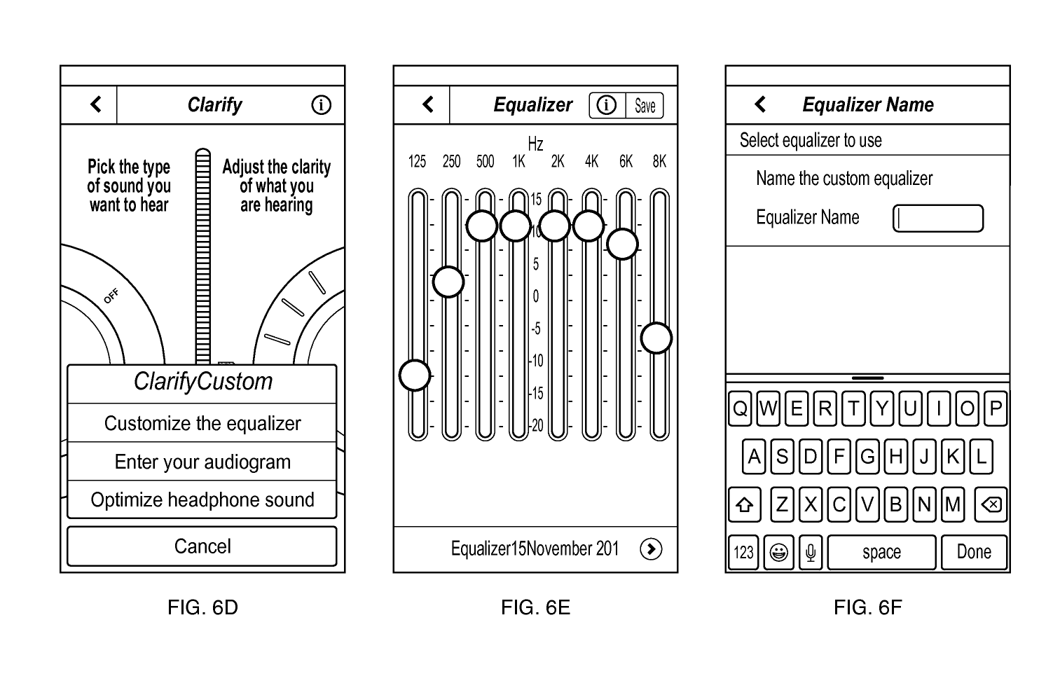

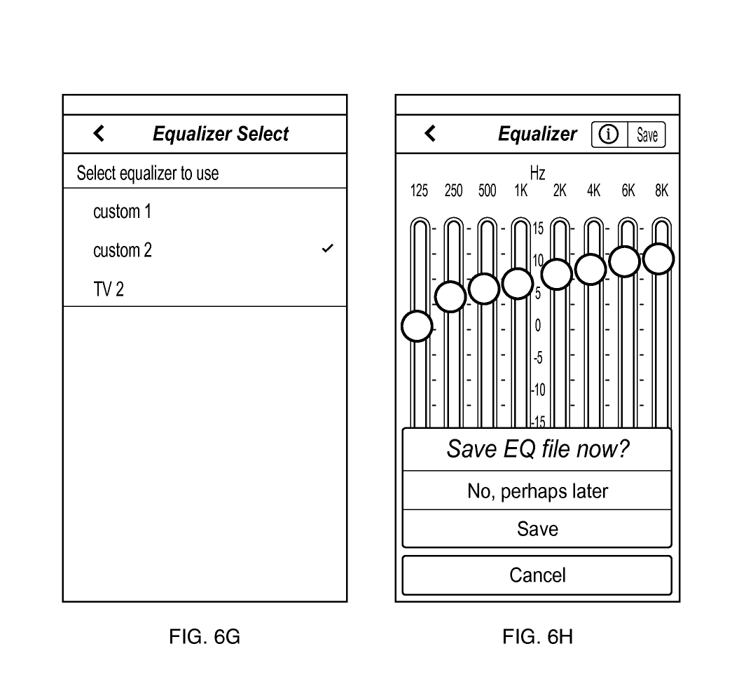

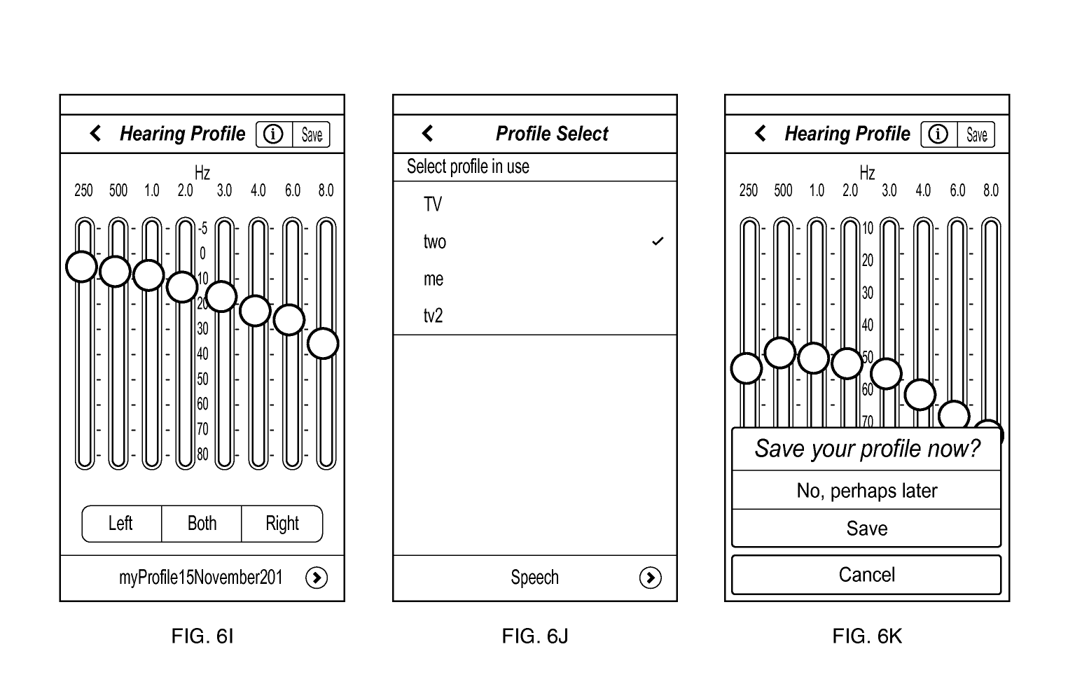

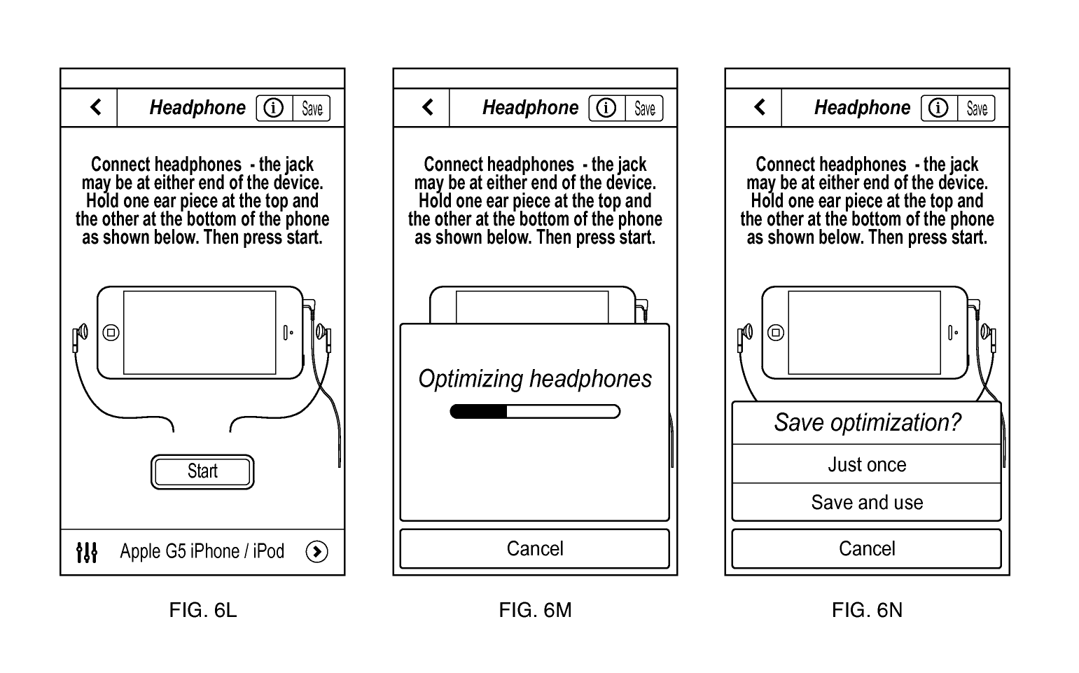

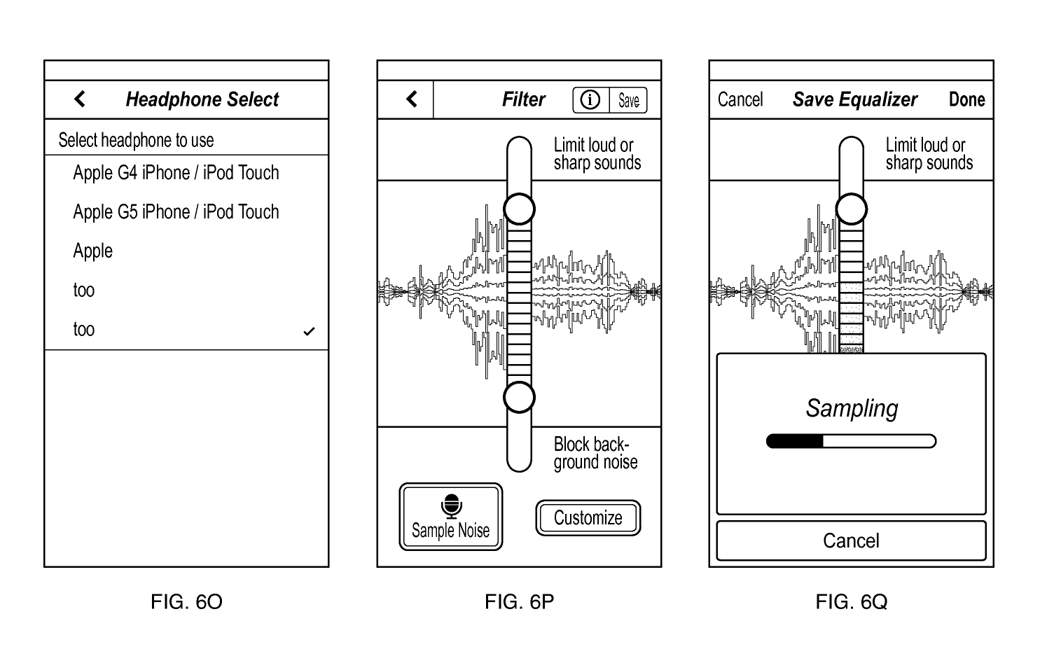

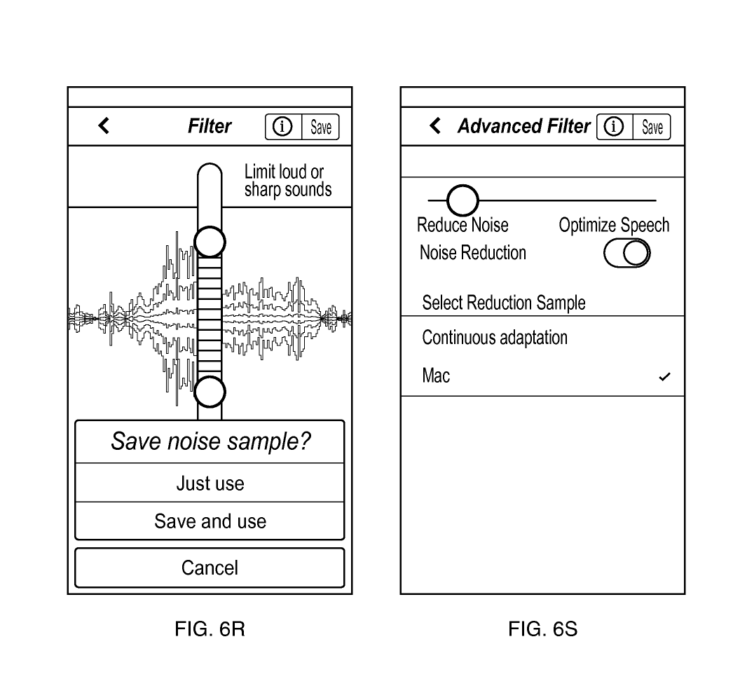

FIGS. 6A-6S depict a set of primary screens of a user interface for an exemplary DSP application running on a mobile computing device, as presented herein. The described screens are for exemplary embodiments implemented on an Apple device supporting iOS 7, which utilizes that devices touch screen interface.

FIGS. 6A-6B Main Screen (“RealClarity”):

The main screen (as well as other screens) has a ‘share’ button and an ‘info’ button in the upper right corner.

The ‘share’ button activates a screen that allows a User to communicate with others about the app. The ‘share’ button can be used to send and share audio profiles, noise profiles, customized equalizer settings, etc.

The ‘info’ button produces a text screen that provides information about source screen.

The main screen (as well other screens), has a vertical display slider which visually shows the presence of audio input through a colored column. If the there is no column displayed then no source input is being received, most often because the ‘On/Off’ button is set to Off.

As depicted, the upper left corner of the main screen includes an ‘option’ icon that when activated reveals the ‘Options’ panel.

When the exemplary embodiment application is loaded, the main screen “RealClarity” is displayed (FIG. 6A). The application is activated by pushing the ‘On/Off’ button control.

Once activated (FIG. 6B), the lighted ‘On/Off’ button indicates the application is active.

Two adjustments for volume are available.

The slider bar labeled “volume” corresponds to overall device volume, which may also be adjusted using hardware buttons on the device, in some embodiments. It is best that this control be close to the maximum as the gain reflected in the setting is out of the purvey of the exemplary embodiment processing.

The ‘boost’ stepper allows the User to change the internal volume (or gain) of the audio as processed by the embodiment. The best sound quality is achieved by first maximizing the hardware volume, and then adjusting, e.g., increasing, the internal volume.

As the volume increases, the likelihood of unwanted audio feedback may increase. The audio feedback may be decreased by reducing either the ‘boost’ stepper or ‘volume’ slider.

The main “RealClarity” screen includes two large buttons, the ‘filter’ button which deals with noise control and the ‘clarify’ button which deals with gain adjustments.

Selecting the “Clarify sound” button will display the “Clarify” screen.

Selecting the “Filter noise” button will display the “Filter” screen.

FIGS. 6C and 6D depict screens for creating and modifying the frequency gain profiles used in the DSP processing.

FIG. 6C “Clarify” Screen:

The ‘Clarify’ screen has two wheel controls and a ‘Customize’ button. The two wheels allow a User to adjust the clarity of the processed sound by modifying a Hearing Profile or an Equalizer Profile. The ‘Customize, button allows the User to create or modify a Profile or activate a stored Profile. Custom settings may be set by spinning the wheel to the setting where one will find the slider icon.

The symbols on the left wheel allow the User to select a pre-set Equalizer Profile setting, for example, Profiles may be selected for Speech, TV, Outdoors, Music, Movie and Live Event. There is an option to select “Off”, which means to not use an Equalizer Profile and a setting, with a tuner icon, which means to use the selected customized Equalizer Profile.

The symbols on the right wheel allow the User to select a pre-set Hearing Profile. The preset Hearing Profiles reflect average hearing loss by age from 40 to 85 years in increments of 2 or 3 years. The age chosen is shown in the small wheel. There is a flat-line setting for ages below 40. In general, the higher the age, the more amplification there is for medium and high frequency sounds. Users can start with a setting close to their age, and then experiment up or down to find the Hearing profile setting that works best for their own hearing preferences and/or in different environments.

Selecting the “Customize” button will bring up the pop-up “ClarifyCustom” screen.

The “Clarify” screen has a ‘return’ control (left carrot) in the upper left corner, as do many other screens, that, if selected, returns to the calling screen.

FIG. 6D “ClarifyCustom” pop-up Screen:

The “ClarifyCustom” screen displays three buttons that allow the User to customize input and has a “Cancel” button that returns to the “Clarify” screen. The User can enable and/or customize a number of features with respect to the clarity of the desired sound.

The “Customize the equalizer” allows the User to enter to enter or modify an Equalizer profile by bringing up the “Equalizer” screen.

The “Enter your audiogram” allows the User to enter of modify a Hearing Profile by bringing up the “Hearing Profile” screen.

The “Optimize headphone sound” allows the User to create a base profile that corrects for frequency anomalies in a wired earpiece by bringing up the “Headphone” screen.

FIGS. 6E-6H depict user interface screens which handle the details of creating, modifying and saving the Equalizer Profiles.

FIG. 6E “Equalizer” Screen:

The “Equalizer screen allows the User to modify the current active Equalizer Profile, which is displayed. The Equalizer Profile shapes sound, much like the treble and bass controls on a stereo, but with more fine-grained frequency tuning. The horizontal axis displays the frequencies that can be set. The key voice frequencies are 500 Hz to 4 KHz. The vertical axis displays the decibels that will be added to the gain of a frequency. The display bar at the bottom of the screen identifies the current active Equalizer profile.

To modify the displayed Equalizer Profile, the User moves the frequency sliders to the shape desired.

The User can then select the ‘return’ control return to the calling Screen:

If the User has modified the frequency settings and selects the ‘return’ control a “Save EQ file now” pop-up screen is displayed.

If the User does not modify the displayed Equalizer Profile and selects the ‘return’ control then the calling screen is displayed and the displayed Equalizer profile remains the active profile.

The User can save or activate a stored Equalizer Profile by selecting the ‘next’ control (right carrot) at the bottom right corner of the screen.

If the User has not modified the displayed Equalizer Profile, the “Equalizer Select” screen is displayed, which allows the user to activate a saved Equalizer profile.

If the User has modified the displayed Equalizer profile, the “Equalizer Name” screen is displayed, which requires the User to name the modified Profile and stores it. On having stored the named Equalizer Profile, the “Equalizer Select” screen is displayed with the newly saved Equalizer activated.

The User can save or activate a stored Equalizer Profile by selecting the “Save” button at the top right corner of the screen.

If the User has modified the displayed Equalizer profile, the “Equalizer Name” screen is displayed, which requires the User to name the modified Profile and stores it. On having stored the named Equalizer Profile, the “Equalizer Select” screen is displayed with the newly saved Equalizer activated.

If the User has not modified the displayed Equalizer Profile, no action occurs.

FIG. 6F “Equalizer Name” Screen:

The Equalizer name screen allows the user to name and save the modified displayed Equalizer Profile. When the name is entered and “return” on the keyboard is selected, the Equalizer Select screen is displayed. The newly stored and named Equalizer Profile will be listed and checked as active.

FIG. 6G “Equalizer Select” Screen:

The “Equalizer Select” screen displays the set of saved Equalizer Profiles. The currently active Equalizer Profile is indicated by a check on the list of saved profiles. The User can activate another Equalizer Profile by selecting a name on the list. The check mark will move to that entry indicating that that profile is now the active Equalizer Profile.

FIG. 6H “Save EQ file now” pop-up Screen:

If the User selects the “No, perhaps later” button, then the currently displayed Equalizer Profile becomes the active Equalizer Profile and the calling screen is displayed.

If the User selects the “Save” button, then the “Equalizer Name” screen is displayed. The User can then name the modified displayed Equalizer Profile and save it. When saved it will be the active Equalizer Profile.

FIGS. 6I-6K depict exemplary user interface screens which handle the details of creating, modifying and saving the Hearing Profiles.

FIG. 6I “Hearing Profile” Screen:

This screen allows the User to modify the current active Hearing Profile (aka audiogram), which is displayed.

The Hearing Profile provides input to the DSP to add frequency-based gain to improve the audibility of Sound. The Hearing Profile contains separate profile components for the right and left ear. The vertical axis displays the decibels that will be added to the gain of a frequency. The vertical bar is inverted so that the frequency display mimics a typical audiogram that shows hearing loss in decibels, which increase at the lower settings. The display bar at the bottom of the screen identifies the displayed active Hearing Profile.

To modify the displayed Hearing Profile component, the User moves the frequency sliders to the shape desired.

The horizontal button bar selects the Hearing Profile component to display. The “Left” button displays the left-ear Hearing Profile component and the “Right” button displays the right-ear Hearing Profile component. If the Hearing Profile left and right components profiles are the same then the User can select the “Both” button. The supplied pre-set Hearing Profile have the same profile for both the left and right ears. Modifications on the “Both” displayed screen will be recorded in both the right-ear and left-ear Hearing Profile components. If there is a difference between the right and left component then modifying the displayed Hearing Profile will only modify the right-ear Hearing Profile component.

The User can then select the ‘return’ control to return to the calling Screen

If the User has modified the frequency settings and selects the ‘return’ control a “Save your profile now?” pop-up screen is displayed.

If the User does not modify the displayed Hearing Profile and selects the ‘return’ control then the calling screen is displayed and the displayed Hearing Profile remains the active profile.

The User can save or activate a stored Hearing Profile by selecting the ‘next’ control (right carrot) at the bottom right corner of the screen.

If the User has not modified the displayed Hearing Profile, the “Profile Select” screen is displayed, which allows the user to activate a saved Hearing Profile.

If the User has modified the displayed Equalizer profile, the “myProfile Name” screen is displayed, which requires the User to name the modified Hearing Profile and then stores it. On having stored the named Equalizer Profile, the “Profile Select” screen is displayed with the newly saved Equalizer activated.

The User can save or activate a stored Equalizer Profile by selecting the “Save” button at the top right corner of the screen.

If the User has modified the displayed Hearing Profile, the “myProfile Name” screen is displayed, which requires the User to name the modified Hearing Profile and stores it. On having stored the named Hearing Profile, the “Profile Select” screen is displayed with the newly saved Hearing Profile activated.

If the User has not modified the displayed Hearing Profile, no action occurs.

FIG. 6J “Profile Select” Screen:

The “Profile Select” screen displays the set of saved Hearing Profiles. The currently active Hearing Profile is indicated by a check on the list of saved profiles. The User can activate another Hearing Profile by selecting a name on the list. The check mark will move to that entry indicating that that profile is now the active Hearing Profile.

FIG. 6K “Save your profile now?” pop-up Screen:

If the User selects the “No, perhaps later” button, then the currently displayed Hearing Profile becomes the active Hearing Profile and the calling screen is displayed.

If the User selects the “Save” button, then the “myProfile Name” screen is displayed. The User can then name the modified displayed Equalizer Profile and save it. When saved it will be the active Hearing Profile.

FIGS. 6L-6O depict exemplary user interface screens which initiate a test of Speakers in a wired earpiece to identify any anomalies in the frequency gain. This is done by executing a Speaker Response Estimator process that results in an active Headphone Profile. The resulting Headphone Profile can be stored for later sessions that use the same earpiece.

FIG. 6L “Headphone” Screen:

Each model of earpiece has its own frequency characteristic or profile. This screen allows the exemplary embodiment to measure that characteristic. Once measured the sample is used to create a profile that is used by the DSP to produce the best sound possible and to minimize the likelihood of audio feedback. The smaller earbuds often have a frequency bump that can cause feedback.

To perform an optimization, the User sets or holds the earpiece as pictured. The best results are obtained 1) by doing it in a relatively quiet place, and 2) by setting the hardware volume control about two-thirds of the way to the right. Then the User selects the “Start” button. The “Optimizing headphone screen” pop-up screen is displayed.

The bar at the bottom of the screen, displays the name of the active Headphone Profile.

FIG. 6M “Optimizing Headphone” Screen:

The optimization process takes about 15 seconds. This screen displays the duration of that optimization process. When the process is complete the “Save optimization?” pop-up screen is displayed.

FIG. 6N “Save optimization?” Screen:

If the User selects the ‘Just use” button, then the computed optimization is the active optimization profile for the current session.

If the User selects the “Save and use” button, then a “Headphone Name” pop-up screen will display. Once the optimization profile is named it will be stored and displayed as the active optimization profile in the “Headphone Select” screen.

FIG. 6O Headphone Select Screen:

The “Headphone Select” screen displays the set of saved Headphone Profiles. The currently active Headphone Profile is indicated by a check on the list of saved profiles. The User can activate another Headphone Select by selecting a name on the list. The check mark will move to that entry indicating that that profile is now the active Headphone Select.

FIGS. 6P-6S depict exemplary user interface screens which provide parameters and Noise Profiles that are utilized by the DSP for noise control.

FIG. 6P “Filter” Screen:

The vertical display bar on the “Filter’ screen has a vertical display slider which visually shows the presence of audio input through a colored column. Users can use the sliders on the vertical bar to reduce noise. The upper slider indicates a gain level that is used by the DSP to recognized sharp, sudden sound that should not be amplified. The lower slide represents the gain level for low frequency audio, e.g., out of the speech range, that should not be damped. The reason these controls are on the slider is to give a User a visual clue on the appropriate settings by seeing visualization of the audio being processed.

The DSP processor has a capability to continuously estimate what is noise in the audio input. However the algorithm works better with a static Noise Profile as long as that profile reflects noise in a stable environment, e.g., the air conditioner noise in an otherwise quiet room in which the User is participating in a meeting, the fairly constant noise produced in a traveling car, and, somewhat ironically, in a very quiet environment so the DSP algorithm does not guess wrong about what is noise and what is speech.

If the user selects the “Sample Noise” button the “Sampling pop-up screen is displayed and the Noise estimating process is initiated.

If the User selects the “Customize” button the “Advanced Filter” screen is displayed where some advanced noise control features are available, and where a saved Noise Profile can be activated.

FIG. 6Q “Sampling” Screen:

The sampling process takes about 5 seconds. It's best to sample when people are not speaking (since one will probably NOT want to filter or eliminate speech), so the User may often ask for a moment of silence. This screen displays the duration of the sampling process. When the sampling process is complete the “Save noise sample?” pop-up screen is displayed.

FIG. 6R “Save noise sample?” pop-up Screen:

If the User selects the ‘Just use” button then the computed Sample Noise Profile is the active profile for the current session.

If the User selects the “Save and use” button then a pop-up screen will require the User to name the Sample Noise Profile. Once the Sample Noise Profile is named it will be stored and displayed as the active Noise Profile in the “Advanced Filter” screen.

FIG. 6S “Advanced Filter” Screen:

The slider on the horizontal bar of the “Advanced Filter” screen allows the user to fine tune the DSP process. This is primarily by affecting the timing of the transition once the DSP process decides that targeted speech has begun or that it has ended. In noisy environments the slider should be moved to the right towards the label; “Reduce Noise”. With this setting the DSP will quickly reduce noise but in the process may clip the beginning of speech. In a quiet environment the slider should be moved to the right towards the label “Optimize speech”. With this setting the DSP will more slowly reduce noise but will avoid clipping any Speech sounds.

The “Select a Noise Filter to Use” section of the screen lists the stored Sample Noise Profiles, with the active Sample Noise Profile indicated by a check-mark. The User can select a different Sample Noise Profile from the list, which is then activated. The “Continuous adaption” profile is always available and is the default, if the user has not created or activated a stored Sample Noise Profile.

If the “Continuous adaption” is active then a parameter is sent to the DSP to do continuous noise estimation.

Exemplary Application:

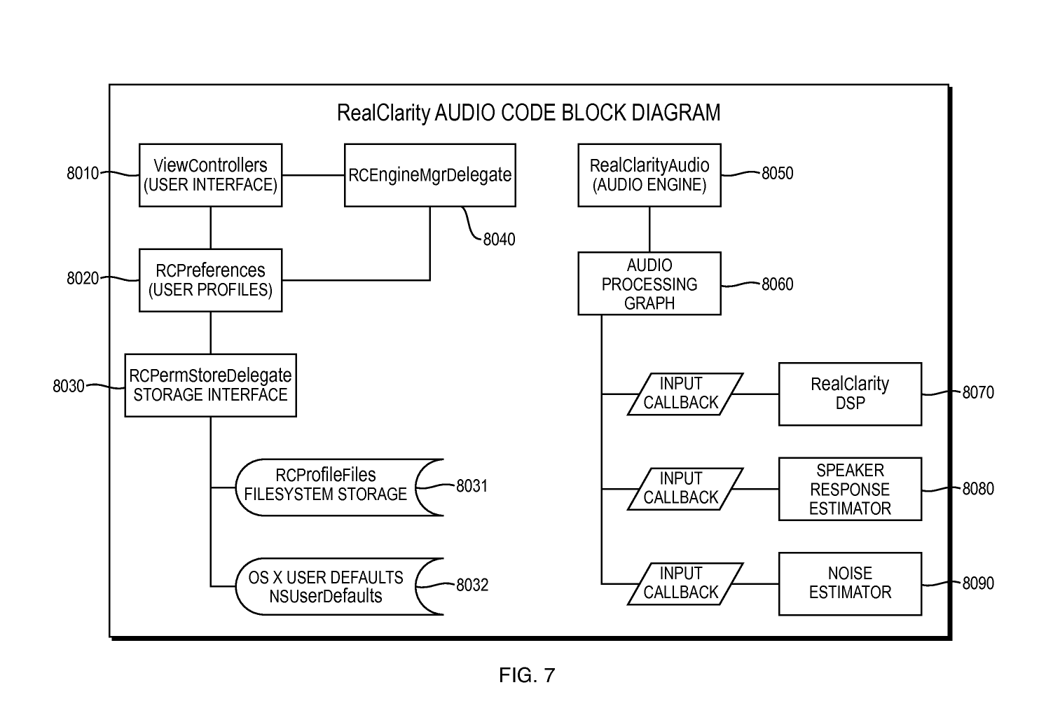

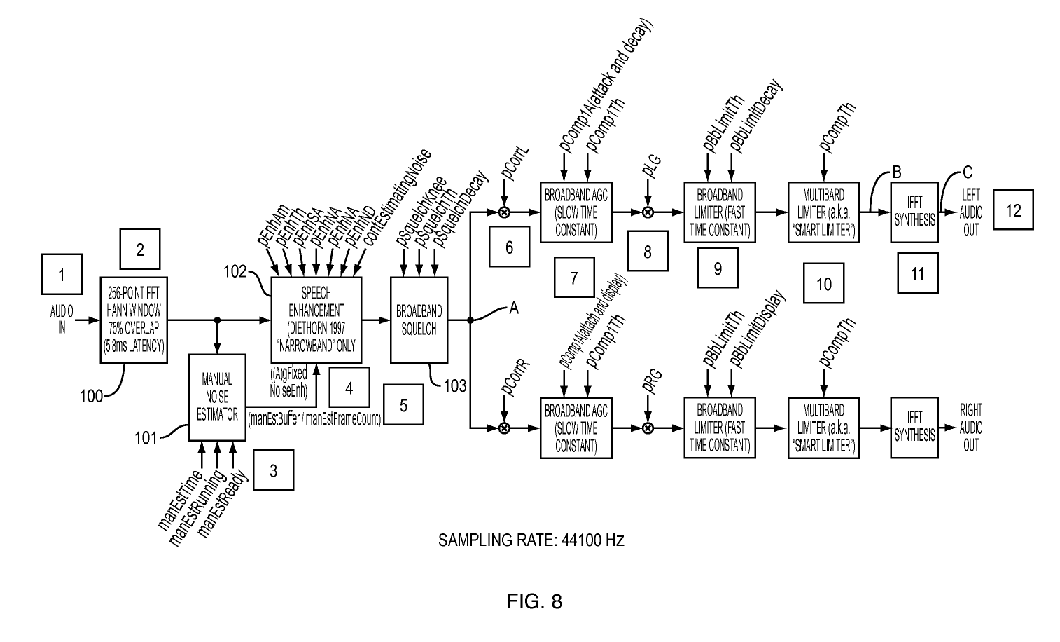

FIG. 7 depicts a block diagram of an exemplary application which may be used in conjunction with embodiments disclosed herein to increase the audibility of targeted speech. The disclosed embodiment of FIG. 7 utilizes the Apple's iOS family of operating systems. Notably, audio processing in the iOS operating system is based on event-oriented processing.

RCEngineMgrDelegate 8040 is the primary event handler, processing events and setting state variables. It is the primary mediator between the general application processes, e.g., the user Interface, and the active audio processing modules.

ViewControllers 8010 manage the display and interaction of the User Interface (UI), e.g., signaling to the RCEngineMgrDelegate that audio processing should be initiated, passing a parameter to the RCEngineMgrDelegate to change in the volume setting. The ViewControllers also communicate with RCPrefernces to display and update User-entered profile information.

RCPreferences 8020 manages the User setable preferences and profiles such as instantiating stored Hearing Profile or Equalizer Profile or retrieving a saved Sample Noise Profile. RCPrefernces interfaces with the RCPermStoreDelegate to either retrieve or update storable User preferences and profiles.

RCPermStoreDelegate 8030 mediates between RCPrefernces and the various mechanisms for permanently storing data, e.g., Hearing Profiles, Sample Noise Profiles, etc., delegating to the appropriate process and indicating the CRUD operation that is required.

RCProfileFiles 8031 stores and retrieve User profiles, such as Hearing Profiles, Equalizer Profiles and Sample Noise Profiles in the iOS file system.

OS X User Defaults 8032 retrieves and updates in permanent storage User preferences and other parameters used when the exemplary embodiment is initiated or are changed during the execution of the exemplary embodiment.

RealClarityAudio 8050 is the audio engine that manages the processing of digital audio. An instance of RealClarityAudio is instantiated when the exemplary embodiment is started and initiates the processing of a digital audio signal by iOS. RealClarityAudio then provides the overall management of the processing, specifically by instantiating the Audio Processing Graph unit.

Audio Processing Graph 8060 is an object that contains an event-oriented flow describing processes to be executed based on call-backs from iOS. These flows provide the key set of functions that need to be executed by the exemplary embodiment to increase the audibility of speech that is being delivered within the digital audio input. The major call-back executes the exemplary embodiment's DSP. Additional call-backs include a Speaker Response Estimator and a Noise Estimator.

RealClarity DSP 8061 contains algorithms that performs the core DSP to increase audibility. These algorithms are described in greater detail in the sections which follow.

Speaker Response Estimator 8062 is a unique process, triggered from a UI screen, that generates white noise that is broadcast through the Speakers of an earpiece and input through the Mobile Computing Device's microphone. The Estimator creates an adjustment profile calibrated to correct gain anomalies in the Speaker of the wired earpiece, based on the difference between the expected noise profile of white noise and the actual noise profile output from the Speaker. The adjustment profile, which is stored, enables the RealClarity DSP to adjust for the anomalies.

Noise Estimator 8063 is a process, triggered from a UI screen, that creates a Noise Profile based on, for example, a 5 sec audio stream of the ambient noise in an environment. This Noise Profile is stored and is then available to be utilized by the RealClarity DSP.

Exemplary DSP Processing Algorithms:

Exemplary DSP processing algorithms for reducing the speech-to-noise ratio and increasing audibility are provided below. These signal processing algorithms can be applied to electronic audio as well as ambient sound. However, as noted above the time constraint on DSP relates to ambient sound where it is important to avoid an echo effect, e.g., to deliver sound to the speaker with an aggregate latency of less than 40 ms.

In general, DSP may be performed on a real-time or high priority thread utilizing Call-backs from the operating environment.

In the exemplary embodiments, the DSP contribution to aggregate latency may be reduced by executing an effective set of algorithms for the DSP, where these algorithms are driven by parametric input. The values of the parameters are derived by background processing, e.g., on lower priority threads, or from user input such that computation of these parameters does not add to the processing latency. The parametric input may either supplied as arguments to the DSP process or indirectly via profiles, sound samples, and state variables stored in a shared common memory space.

An effective set of DSP algorithms may include, but is not limited to, gain control and gain shaping, frequency gain adjustment, frequency mapping, dynamic range compression, noise suppression, noise removal, speech detection, speech enhancement, detection and suppression of non-speech impulse sound.

FIG. 8 depicts an exemplary set of DSP algorithms that have been implemented for mobile devices running Apple's iOS operating environment. Cross-reference is made at times to the exemplary user profile of FIGS. 6.1-6.19. The digital signal processing takes a frame of digital audio input in the time domain, transforms it into a Frequency Spectrum using a Fast Fourier Transform, processes that Frequency Spectrum and reconstructs a frame of digital audio output. There may be averaging or smoothing done between sequential Frequency Spectrum and between time domain audio frames. The DSP processing time, including buffering, is designed to take less than 10 ms.

As depicted, DSP may be based on a filter bank architecture with the following components:

Audio Input 1 of FIG. 8

The audio input 1 is a digital stream that can come from a number of sources, such as the electronic sound from applications running on the mobile device or telephone conversations. In the exemplary embodiment, the primary audio input comes from an analog-to-digital converter which receives its analog signal from an internal microphone or from an external microphone.

Fast Fourier Transform (FFT) 2 of FIG. 8

The time domain signal is then converted to the frequency domain using a Fast Fourier Transform 2 by transforming a time frame with 256 samples to a Frequency Spectrum of 256 bins where the frequency is represented by a complex number indicating the amplitude and phase of the bin.

All FFT-based measurements assume that the signal is periodic in the time frame. When the measured signal is not periodic then leakage occurs. Leakage results in misleading information about the spectral amplitude and frequency. The exemplary embodiment applies a Hann Window transformation to reduce the effect of leakage.

One of the disadvantages of windowing functions like Hann is that the beginning and end of the signal is attenuated in the calculation of the spectrum. This means that more averages may be taken to get a good statistical representation of the spectrum. This may increase the latency of FFT algorithm. A 75% overlap process is implemented in the exemplary embodiment where only 64 samples are added and the remaining 196K come from the previous window. This moving average approach minimizes latency while compensating for the attenuated signal. The expected latency including the buffering of the time frame and the delay because of the averaging is estimated to be 5.8 ms.

Manual Noise Estimator 3 of FIG. 8

The speech enhancement process 4 has a capability to perform continuous noise estimation, e.g., estimate what is noise. However, if a User is in a stable noise environment the speech enhancement algorithms work better with a fixed measurement of the noise profile. The Manual Noise Estimator 3 process gets input from the FFT process and creates a stable Noise Profile. The Noise Profile is output as a Frequency Spectrum, which then can be input to the Speech Enhancement process.

In the exemplary embodiment, the creation of a noise sample by the Manual Noise Estimator process is initiated by the User pressing the “sample noise” control in the Filter screen (see, e.g., FIG. 6P). Sound is then gathered for a period of five seconds, the sound is transformed by the FFT process and input to the Manual Noise Estimator process that will create a Noise Profile. The created Noise Profile is then stored in the Noise Profile buffer where it will then be accessed by the Speech Enrichment process.

Given the creation of the Noise Profile (see, e.g., FIG. 6Q), the User has the option of naming and saving the created Noise Profile for later use (see, e.g., FIG. 6R). Rather than creating a current noise sample the User can select a stored Noise Profile (see, e.g., FIG. 6S). The selected Noise Profile will be stored in the Noise Profile buffer where it can be accessed by the Speech enhancement module.

There are three parametric arguments to the Manual Noise Sample process that are used to inform the process controller of the status of the Noise Profile creation:

| # | Argument Name | Argument Description |
|---|---|---|
| 1 | manEstTime | How much time has elapsed in gathering the |
| | | noise sample |
| 2 | manEstRunning | (Boolean) is the noised sampling running |
| 3 | manEstRunning | (Boolean) is noise sampling ready |

Speech Enhancement 4 of FIG. 8

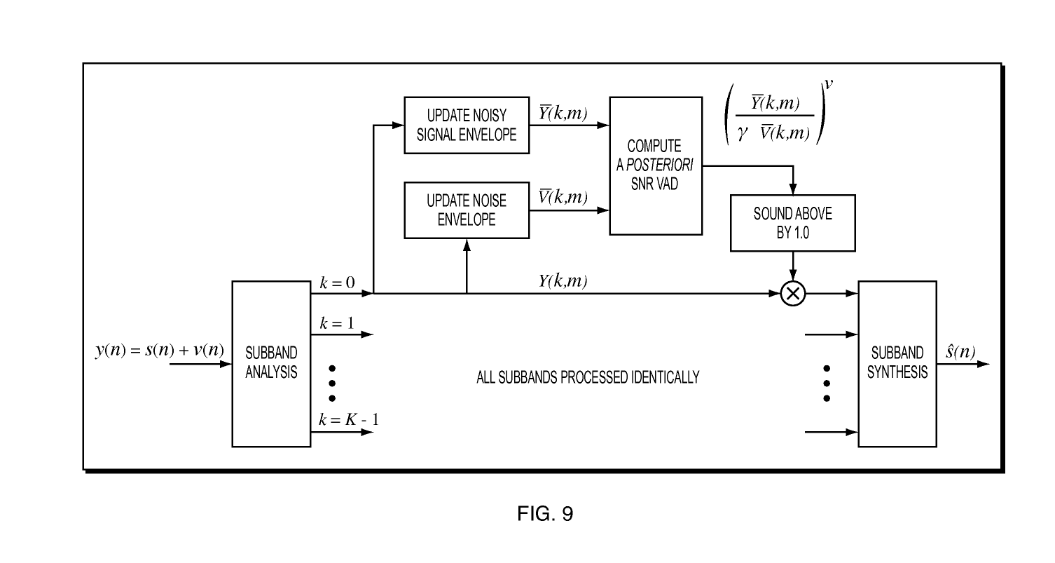

In the exemplary embodiment, the Speech Enhancement process 4 is a core process for improving the speech-to-noise ratio by removing noise from the audio input. The process implements an algorithm described by Diethorn (SUBBAND NOISE REDUCTION METHODS FOR SPEECH ENHANCEMENT, Eric J. Diethorn, Microelectronics and Communications Technologies, Lucent Technologies) that is “less complex” so that it does not significantly add to the aggregate latency. The algorithm consists of four key processes: sub-band analysis, envelope estimation, gain computation, and sub-band synthesis (see, e.g., FIG. 9).

The Speech Enhancement algorithm is designed to continually estimate the noise component of the audio input ( V̅(k,m) in FIG. 9)

However, if the User has indicated that a Manual Noise estimate should be used, then the Frequency Spectrum stored in the Noise Buffer will be used.

The Speech Enhancement process also estimates when speech is present through a soft Voice Activity Detection algorithm (VAD). The VAD limits the possible gain reduction for noise. In some situations, in may be possible to substitute a background-computed time-domain estimate of when speech is present. The time domain estimate may be more accurate and may allow more flexibility in terms of gain reduction.

There are seven arguments that the Speech Enhancement process. Two of the parameters control a tradeoff between increasing noise identification and delivering clearer speech. A User can set the balance of this trade-off by modifying a slider on the Advanced Filter screen (see, e.g., FIG. 6S).

There are four parameters, used for a smoothing function, that indicate how to transition to Speech and to noise. These parameters are preset, but can be changed through a “back-door” UI available to a developer. There may be situations where different parameter sets will be used depending on the environment.

There is also a Boolean argument that indicates whether a manual noise estimate is to be used.

| # | Argument Name | Argument Description |
|---|---|---|
| 1 | pEnhAm | Amplitude |
| 2 | pEnhTh | Threshold |
| 3 | pEnhSA | The attack smoothing parameter for start of |
| | | speech |
| | pEnhSD | The decay smoothing code for end of speech |
| | pEnhNA | The attack smoothing code for start of noise |
| | pEnhND | The decay smoothing code for end of noise |

The output of the Speech Enhancement process is a Frequency Spectrum with an increase in Speech-to-Noise ratio.

Broadband Squelch 5 of FIG. 8

While the Speech Enhancement process 4 increases the Speech-to-Noise ratio, it can be advantageous to remove low frequency sounds that are not part of speech, such as the rumble of an air conditioner or other machinery. In the exemplary embodiment, the Broadband Squelch process 5 removes these frequencies from the Frequency Spectrum. While that low frequency noise will still be heard by Users as ambient sound reaching their ears, it will not be presented in the audio output for the Speaker.

The level of low frequency sound to be removed is chosen by the User by setting the lower slider control on the slider bar on the Filter screen (see, e.g., FIG. 6P).

The Broadband Squelch has three controlling arguments:

| # | Argument Name | Argument Description |
|---|---|---|
| 1 | pSquelchKnee | Controls how the Squelch is averaged in |
| 2 | pSquelchTH | The squelch threshold as indicated by the User |
| 3 | pSquelchDecay | The length of smoothing to remove the Squelch |
| | | when the low frequency noise is gone. |

The output of the Broadband Squelch process is a Frequency Spectrum with the low frequencies appropriately removed.

User Profile 6 of FIG. 8

One of the important features of hearing assistance is to be able to adjust the gain of different frequencies to match the User's hearing ability and hearing preference.

In the exemplary embodiment, the User Profile process 6 accesses a Profile buffer, which is constructed by combining a Hearing Profile and an Equalizer Profile, to adjust the gain for frequencies in the Frequency Spectrum that is output from the Broadband Squelch process.

Since the User's hearing may vary between left and right ear, separate Hearing Profiles can be constructed for each ear, which are then combined with Equalizer Profiles, so that separate left ear and right ear profile buffers are provided to the DSP where separate left and right gain adjustments can be made.

In the exemplary embodiment, Users have two ways to set up an appropriate Hearing Profile:

On the Clarify screen (see, e.g., FIG. 6C), the right-side wheel allows a User to select one of a number of pre-stored Hearing Profiles. The pre-stored Hearing Profiles, for example, can represent average hearing loss profiles by age. The stored Hearing Profiles cover the normal frequency range and decibel deficit that are used in standard hearing tests. While Users may initially select a Hearing Profile that reflects their age, they may experiment through use and find other profiles that better match their hearing needs. The innovative use of these pre-stored Hearing Profiles allows many Users to adjust the sound output, such that they do not have to use the results of a hearing test to adequately meet their hearing needs.

Users can enter an audiogram that represents their personal hearing needs. This is done on the Hearing Profile screen (see, e.g., FIG. 6I). The User is given the option of entering one profile for both ears or entering separate profiles for each ear. Users with moderate to severe hearing loss and those with distinctive hearing needs are best suited to utilize the custom entry of an audiogram. Entered audiograms can also be named and saved so that a User can define different Hearing Profiles for different situations and environments. A User can select a named Hearing Profile on the myProfile screen. To use an entered Hearing Profile, the right-side wheel on the Clarify screen is set to the array icon.

In the exemplary embodiment, the User can make additional adjustments to fit particular sound situations or their own hearing preferences by adjusting the Equalizer Profile, e.g., emphasizing the frequencies most used for speech, increasing the higher frequencies to get a better experience listening to music. The Equalizer Profile defines a set of additive gain amounts that modify the Hearing Profile.

In the exemplary embodiment, Users have two ways to setup an appropriate Equalizer Profile:

On the Clarify screen (see, e.g., FIG. 6C) the left-side wheel allows a User to select one of a number of pre-stored Equalizer Profiles. The pre-set Equalizer Profiles have frequency gain settings for common sound situations.

Users can enter a customized profile on the Equalizer screen (see, e.g., FIG. 6E), the amount of gain adjustment is indicated in the central vertical scale. Entered Equalizer Profiles can also be named and saved so that Users can define their own set of profiles for different sound situations and environments. A User can select a named Equalizer Profile on the Equalizer Select screen (FIG. 6G). To use an entered Equalizer Profile, the left-side wheel on the Clarify screen is set to the array icon.

Broadband AGC 7 of FIG. 8

The Broadband AGC (automatic gain control) process 7 adjusts the overall gain of the Frequency Spectrum to compensate for volume changes in the sound environment, e.g., going from a quiet environment to a loud environment. This is to make sure that a User does not hear any abrupt changes in the sound from the Speaker. The Broadband AGC process is important as it removes the threat that delivered sound from the Speaker may be loud enough to damage a User's hearing ability. The Broadband AGC process measures a moving average of the audio energy represented in the Frequency Spectrum to ascertain significant changes and will limit the absolute gain and will smooth the gain during an environmental transition. This Broadband AGC process cannot operate at low levels of sound energy, as the results may be too volatile, so an energy threshold may be set that indicates the energy level when the automatic gain control is activated.

The Broadband ADC process has two controlling parameters:

| # | Argument Name | Argument Description |
|---|---|---|
| 1 | pComp1A | Controls the introduction of the Squelch |
| 2 | pComp1Th | Threshold needed to activate the automatic |
| | | gain control |

The output of the Broadband AGC is an adjusted Frequency Spectrum.

Volume Control Process 8 of FIG. 8

In the exemplary embodiment, in addition to setting the hardware volume, Users have the option of setting a software volume level. The software volume is set on the main RealClarity screen using the “boost” control. The Volume Control process 8 adjusts the gain in the Frequency Spectrum for each time frame to reflect the volume control setting specified by a User. Offering the software volume control is important as it means that knowledge of the volume level and specifically changes in the set volume level are known to the DSP. The performance of the DSP is affected by the volume setting, in particular if the volume is too high feedback can be introduced. The best practice for a User may be to set the hardware volume at one level near its maximum and only modify the software volume control.

The Volume Control process has one control parameter:

| # | Argument Name | Argument Description |
|---|---|---|
| 1 | pLG | Gain level that corresponds to the USER |
| | | set volume control |

The output of the Volume Control is an adjusted frequency Spectrum.

Broadband Limiter Process 9 of FIG. 8

When a sudden loud noise occurs, which has a broad frequency spectrum, it can distract from the normal speech processing, e.g., a plate drops making a loud noise next to a User talking in a restaurant. The Broadband Limiter process 9 recognizes a potential loud noise interruption through a sudden increase to a high level in the energy of the audio signal. On recognizing the appearance of a sudden noise, the Broadband Limiter will reduce the overall gain in the Frequency Spectrum.

The level of volume that is to be considered a sudden loud noise is chosen by the User by setting the upper slider control on the slider bar on the Filter screen (see, e.g., FIG. 6P).

The Broadband Limiter has two controlling parameters:

| # | Argument Name | Argument Description |
|---|---|---|
| 1 | pBblimitTH | The energy threshold that constitutes a loud noise |
| 2 | pBblimitdecay | The length of time where the gain is returned to |
| | | normal when the noise has abated |

The output of the Broadband Limiter process is a modified Frequency Spectrum.

Multiband Limiter Process 10 of FIG. 8

It is possible that the Frequency Spectrum contains non-zero amplitude for frequencies outside of the range for which the Speaker can produce sound. In that case the Speaker will produce sound at its maximum for all frequencies above that physical limit. This will produce distortion. The Multiband Limiter 10 cuts off these high energy peaks preventing that distortion.

The Multiband Limiter process has one controlling parameter:

| # | Argument Name | Argument Description |
|---|---|---|
| 1 | pCompTh | Threshold level to cut off the high energy peaks |

The output of the Broadband Limiter process is a modified Frequency Spectrum.

Inverse Fast Fourier Transform 11 of FIG. 8

The Inverse Fast Fourier Transform 11 converts the Frequency Spectrum produced by the DSP back to a time domain audio signal.

The process is based on the Diethorn algorithm that accurately reconstructs the audio stream. The Diethorn algorithm is designed so that if the audio input signal 1 is transformed by the Fast Fourier Transform 2 and the resulting Frequency Spectrum is then inverted by the Inverse Fast Fourier Transform 11, with no intervening processing, the original audio signal will be near perfectly reproduced.

Audio Output 12 of FIG. 8

The reconstructed Audio output 12 of the DSP is received at a digital-to-analog converter, which may be integral with the mobile computing device or external to the device, e.g., in an earpiece/speaker unit. The analog signal is sent to the Speaker, which produces the processed sound for the User. Transmission to the Speaker can be through wired connections, for example, utilizing a standard audio jack or USB connector that is part of the Mobile Computing Device. Transmission can also be through a radio component utilizing standard transmission protocols such as analog FM, digital FM, as long as the latency of that transmission maintains an aggregate latency of under 40 ms. The exemplary embodiment includes an invention of a proprietary Bluetooth protocol. Use of the proprietary Bluetooth protocol requires a modification of the DSP algorithm.

Additional Optional Implementations:

Optional Speech Detection:

In exemplary embodiments, the aggregate latency may be reduced by forgoing or reducing the need to analyze the audio input in the frequency domain (e.g., by performing a Fast Fourier Transform). In some embodiments, either or both time and frequency domain Voice Activity Detection may be utilized by processing the audio input in a separate thread that identifies Speech in the time-domain. Processing in this (time domain) thread may include dividing the audio signal, at regular intervals reflecting the acceptable latency, into two frames—a small frame and large frame. The energy parameter (E) is calculated by frequency from the small frame and the calculated energy (E) is used to detect a start-point and endpoint of audio that is identified as speech. It is initially identified in the speech mode where a pitch period (P) is detected and measured from the large frame, and the pitch detection is used to determine whether there is voiced speech to validate that the audio is speech and may be identified as speech mode. The start and end of speech, as detected in this thread, may be sent as an argument to the DSP process.

This disclosed embodiment may utilize a unique two-step method to detect speech sounds. Once the speech is detected the speech can be amplified and non-speech sound can be reduced or suppressed. An aspect of the embodiment is designed to detect speech in a short time. This is required if the latency between the processed speech and speech sound arriving directly to the listener's ear is too long, the listener's brain will not integrate the two sounds and speech clarity may be lost in the confusion of sound echoing.

In example embodiments, speech endpoints are detected in real time utilizing the computing power of an appropriate mobile device. The technique addresses a major constraint for detecting speech on such devices. One of the important requirements for hearing enhancement is that the time delay caused by processing the speech may be very short. The short period is defined as the time the majority of listeners may not hear the delay between the speech being processed and the unprocessed ambient speech directly reaching a listener's ear. Listeners may not hear the delayed sound because as long as the latency is very short, the listener's brain will integrate the two sounds. If the latency caused by the processing is longer, the latency may be noticeable and listening to the processed speech sound may be annoying or confusing.

The embodiment describes a method that detects speech so that the latency of processing speech on a mobile device, including the built-in latency for the required processing of the device's operating system to input and output the sound, is very short. In digital signal processing, speech detection (or voice activity detection (VAD)) has been widely used in applications of speech recognition and wireless phone communication. Speech detection identifies the starting and ending points of speech versus the ambient noise. Speech detection is typically based on changes in short time sound energy, some algorithms use additional parameter such as crossing rate (number of times the signal has crossed the zero value) for assistance. This mechanism works because when someone talks, they may talk louder than the background noise to be heard. This increase in sound energy can then be interpreted as speech. The embodiment first assumes a certain ambient noise level derived either from the beginning of the input signal or from manual training, and establishes a speech threshold a few dB above the noise level. It then continuously measures the input short time (10 20 ms frames of data) energy. When the input short time energy exceeds the speech threshold for a period of time (N), it decides that the speech has started. When the input signal is in speech and the short time energy drops below a threshold set close to the background noise level for a period of time (M), it decides that the speech has ended. To avoid false trigger of speech by short duration loud noise, the time period (N) for speech trigger may range from 50 ms to 200 ms. Once the speech start is detected, the system back tracks the input signal by the time period (N) to mark it as the real starting point of speech. The time period (N), therefore, is the delay of speech detection.

Speech recognition systems utilize methods with delays of up to about 200 ms, as these systems are not providing real-time hearing assistance. For wireless communication, (N) can be as short as 50 ms. However, in these systems if (N) is too small, many short duration loud noises such as a tap on the table may trigger speech detection. Another problem with current speech detection systems when related to hearing assistance is the recognition that the ambient noise level has increased, such as when a person has just walked into a noisy restaurant. The increased sound energy may cause the higher level of ambient noise to be detected as speech. Current speech detection systems utilize some mechanism, such as automatic reset after a long period of continuous speech (e.g., tens of seconds) or by a manual user reset, to readjust the ambient noise level. Thus, current speech detection methods, with a speech detection latency of 50 ms to 200 ms), and slow adaptation to ambient noise level, cannot be effectively utilized in hearing enhancement applications. This embodiment proposes a two-step method of speech detection to overcome the weakness as mentioned above. Once speech is detected, that speech can be amplified and background noise suppressed or reduced.

This two-step method is used for detecting speech with very little delay and adapting to ambient noise quickly. In the following, this method is described with specific parameters and means. However the same idea can be applied with different parameters and means.

Input signal is divided into two sequences of frames with frame size of 20 ms and 40 ms, respectively. Both sequences have the same frame interval of 10 ms, that is, for every 10 ms of input signal, a pair of frames, one with frame size 20 ms and one with frame size 40 ms are obtained. Therefore, the decision made based on a pair of frames (small and large) has an inherent delay of 10 ms.

Two parameters are calculated from the pair of frames, a total energy (E) is calculated from the small frame, and a pitch period (P) is detected and measured from the large frame. Energy calculation and pitch measurement are well known prior art that can be found in many digital signal processing textbooks and publications. When the input signal volume increases, either from noise or from speech, the energy (E) value may increase. For human speech, vowels or voiced speech contain pitches that are caused by vibration of the vocal cord and display a periodic pattern. Human voice pitch frequencies range from 100 Hz to 400 Hz, which translate to pitch period of 10 ms to 2.5 ms. Since background noise rarely presents such periodic pitch pattern, detection of voiced speech or pitches is a reliable indication of speech, even in a noisy environment. However, not all speech is voiced. Most consonants such as “f's” are unvoiced that don't have pitches and are difficult to distinguish from noise. Fortunately, almost every word contains voiced speech, and the beginning consonant is short, typically 20 100 ms long, and the transitional period from consonant to vowel typically shows some pitch pattern as well. A large frame of 40 ms contains multiple pitch cycles and can result in more reliable pitch detection and measurement.

The two-step method uses the energy to detect endpoints of speech, and the pitch detection to determine whether there is voiced speech. The energy-based speech detection responds quickly to speech, in 10 ms as determined by the frame interval. Such short delay is critical for hearing enhancement applications. However, it can be easily triggered by increased noise as well. The pitch-based voiced speech detection distinguishes real speech from increased noise, but it takes longer duration (a few dozen milliseconds to a few seconds) to make a decision. If no voiced speech is detected after speech trigger, the detected speech is cut short and the speech detection threshold is updated to the increased noise level. The effect of such a two-step approach is that when non speech background noise increases, such as the approaching of a car, wind, start of car engine or music, one may hear the noise for a short duration (e.g., 12 seconds) and then it may be suppressed and the energy-based speech detection threshold may be adapted promptly.

The speech detection algorithm has two modes, noise mode where input signal is assumed as noise, and speech mode where input signal is assumed as speech. An input frame is labeled as “noise” in noise mode, and “speech” in speech mode, until the detection mode switches from one to another. When speech is detected, it switches from noise mode to speech mode# when speech ends or cut short, it switches from speech mode to noise mode. The algorithm starts with noise mode. The following outlines the speech detection algorithm:
1. For every 10 ms of input signal, an energy (E) is calculated from the small frame.
2. In noise mode, if (E) is above a speech detection threshold (T), detection enters speech mode and the current frame is labeled as speech# otherwise, update the overall noise level in sequence of previous “noise” frames, adapt the speech detection threshold (T) to the new noise level.
3. In speech mode, for every 10 ms of input signal, a pitch measurement is calculated from the large frame. If pitch is detected and the pitch period is between 2.5 ms and 10 ms, the frame is labeled as ‘voiced’. For a predetermined duration (M), typically between 100 ms-5 seconds, if the number of “voiced” frames exceeds a threshold (L), it is determined that there is real voiced speech in the current speech mode# otherwise, there is no voiced speech and the speed mode is invalid, and:
   a. the current frame is labeled as noise and detection mode switches to noise,
   b. if no voiced speech has ever been detected in the current speech mode, update the overall noise level in sequence of previous frames including those labeled as “speech” in the same speech mode, and adapt the speech detection threshold (T) to the new noise level.
4. In speech mode, if energy (E) is below a “none speech” threshold (Tn) continuously for a certain time period (Q) (typically 200 ms to 4 seconds), it is determined that speech has ended and the detection mode switches to noise mode.

In another configuration, the voiced speech detection based on pitch measurement can be running continuously also in noise mode to reliably obtain a noise reference model. When voiced speech is detected, the frame is labeled as speech and the detection enters speech mode, and the speech detection threshold (T) is further lowered to reflect low signal to noise ratio. This configuration may work better in a very low signal to noise ratio environment where energy level alone has difficulty distinguishing between noise and speech.

As described above, the energy-based speech detection depends on a threshold (T), which is set based on the noise energy. Therefore, the robustness of the detection depends on the reliability of obtaining a noise reference. Pitch detection can be used to reliably obtain a noise reference in the noise mode by detecting a period of sound at least one or a few seconds long where no pitch is detected, denoting this period of sound as unvoiced sound. By discarding the beginning and ending parts (e.g., a few hundredths milliseconds each) of this unvoiced sound, the center part of the unvoiced sound can reliably serve as noise reference. Since every word contains a voiced vowel, while an unvoiced consonant usually does not last longer than a few hundredths milliseconds and can only occur at the beginning or ending part of the unvoiced sound—possibly passing over from a previous word or the beginning of a following word—the center part of the unvoiced sound contains neither voiced vowel or unvoiced consonant. Such noise reference can be periodically updated to reflect the changing environmental noise.

In order to further improve detection in soft speech, which energy may be very close to the background noise, a filter bank can be used to obtain a set of energy values across a frequency spectrum for speech detection instead of the total energy. A filter bank is an array of band pass filters covering the voice spectrum, such as from 100 Hz to 5000 Hz, with each band pass filter covering a different frequency sub band. A soft speech, typically an unvoiced consonant, has higher energy in one or more sub bands even when its total energy may be very close to the background noise. For example, the consonant “f” or “s” has higher energy in frequency sub band of 2000 Hz and above. A filter bank output therefore can be used to detect speech in each frequency sub band, which is more sensitive than the total energy. In steps 2 and 3 of the above algorithm outline wherein the speech detection threshold (T) (or an array of energy from a filter bank) is adapted to the new noise level, the adaptation may use different speeds depending on whether the noise level is increasing or decreasing and on the distance of energy level of previous detected voiced speech from the noise level. Faster adaptation to lower noise level makes it more likely to detect soft speech in rapidly changing ambient noise. And if the distance of energy level of detected, voiced speech from the noise level is small (an indication of low signal to noise level), speech detection threshold (T) may be set lower to more easily detect soft speech.

Additional Hearing Profile and Equalizer Settings:

In exemplary embodiments, a number of additional techniques may be implemented to create or modify a Hearing Profile:

A facility may be offered that allows a User to take a “standard” hearing test and create and store a resulting audiogram. The hearing test may be implemented by having the User recognizing whether they can hear a sound of a certain frequency and depreciating gain on frequency until it cannot be heard. Given that the hearing test may utilize the same earpiece and speaker system that the User will use for Hearing assistance, the resulting audiogram can be more useable than an audiogram resulting from an externally administered hearing test. Also the hearing test may be performed in controlled but different auditory settings, potentially providing more accurate audiogram variants.

A speech intelligibility test may be offered to more precisely deal with a particular User's audibility. The intelligibility test may be accomplished by playing words at various levels of sound and noise. The result of the intelligibility test, for example, an inability to distinguish certain consonants, may be provided to an enhanced DSP that may be able to process the information and moderate that User's intelligibility issues.

In some embodiments, a number of additional techniques may be implemented to create or modify an Equalizer Profile:

A facility may be offered for a User to create paired equalizer setting for left and right ears. This may be especially useful for those where there is a marked difference in audibility between the left and right ear.

An advanced facility may be offered which may automatically utilize different Equalizer Profiles based on an analysis of the audio input being processed. For example, different Equalizer Profiles may be selected as a User went from a quiet to a noisy environment or switched from listening to music to listening to targeted Speech. A UI may be provided to the User to associate Equalizer Profiles with an audio environment.

A Profile-builder module may be used that allows the User to create or edit various frequency-based profiles, to test the profiles based on stored exemplary speech and noise samples, to name and store the profiles.

In some embodiments, the speech intelligibility aspect of a hearing test may be accomplished by playing words at various levels of sound and noise. The processor may take information from the speech test to enhance and/or modify the basic hearing profile.

Features for Advanced Controls and User Interface:

Exemplary embodiments may have the following additional User Interface features and controls:

Controls to record and store any input audio or processed audio on the Mobile Computing Device's local storage or in the Cloud: Such example embodiments may have controls to access the stored audio, so a User may re-hear the stored audio; controls to reprocess the stored audio, for example, to create or refine Profiles and re-sample noise; and controls to utilize restored audio in a hearing test.

Controls to set a preferred volume level: This may be implemented by allowing Users to select a volume level utilizing prerecorded sound. The embodiment may use the selected sound level to adjust for gain changes in the real-time audio input.

A facility to be trained to recognize a keyword such that when a User utters that keyword the embodiment expects a following command phrase: The embodiment may provide a set of audio command phrases as an alternate User Interface.

Interaction with Other Applications:

In some embodiments, the DSP application may integrate with the other applications available on the mobile computing device.

For example, in some embodiments, the DSP application may reduce or mute the gain from the electronic audio that is produced by another application, allowing processed ambient sound to be heard by a User. Such embodiments may also have a UI control that explicitly switches between electronic audio and ambient sound processing.

Given appropriate access to the electronic audio streams produced by other applications, including telephone conversations, such embodiments may process the electronic audio in the same manner that ambient sound is processed, so that Users may get the benefits of hearing assistance for electronic audio.

Exemplary embodiments may include explicit mechanisms for other applications to provide audio input, allowing the other applications to take advantage of the “always-on” audio connection with a User. For example, Users may get appointment reminders whispered in their ear, and be connected to body-area health monitors where they may, for example receive and audio warning of unusually high blood pressure.

Exemplary Low-Latency Wireless Transmission:

An example low latency Bluetooth link is presented herein for reducing communication latency (e.g., between a mobile computing device and an earpiece). Notably many of the same concepts for reducing latency can also be applied to other wireless links such as WiFi. Low latency, low power, and resilience to RF data loss are all achieved using the exemplary embodiments described herein.

The Bluetooth radio link is comprised of various packets sent in “time-slots” where a time slot is 625 micro-seconds. There are two main types of packets—synchronous (SCO and eSCO) and asynchronous (ACL). The synchronous packets were designed to carry voice signals, whereas the asynchronous packets are designed to carry data. The SCO packets are real-time and provide no recovery for lost packets. eSCO has a modest retransmit capability and ACL has a full back type protocol to insure data reliability at the expense of uncertain delivery time.

Bluetooth profiles determine the type of packets that are used for each case. For wireless headsets two profiles are almost universally supported. One is called HFS (Hands Free) and the other is called A2DP. HFS uses SCO packets and sends data via the RFCOMM API, a serial port emulation port that uses +AT commands to control call setup, select modes, etc. HFS supports bi-directional calls but only 64 kbps data rates—mono and low fidelity. A2DP uses ACL packets and sends data via the GAVDP Interface. It is uni-directional and can support data rates up to 721 kbps.

Neither of these profiles are suitable for bi-directional transport of audio with a bandwidth of up to 8 KHz. Other implementations have bypassed the RFCOMM portion of the stack to get around the delay that it causes.

In order to minimize the delay of sending audio over the Bluetooth link, several areas may be optimized including:
1. The protocol layers—profile customization may be used to support the new mode and minimize delay. The profile may mimic the input for an A2DP profile, in which case a receiver that handles the A2DP profile may be useable. Alternatively a third profile beyond the standard HFS and A2DFP protocols and may be used which may require specialized receivers.
2. The audio coder—optimized by coding for error recovery at both the bit and packet level.

The coder also handles bit rate synchronization due to the difference in clock signals of the Bluetooth link and the sampling rate of the signal chain.
3. Optimizing data transfer from the signal processing chain to the input buffer of the radio link.
4. Optimizing the latency in signal processing chain when it converts from an oversampled FFT domain to a critically sampled voice coder. This is the focus of the innovation discussed here.

One innovative aspect of the embodiments disclosed herein includes the audio coding and how it interfaces to the signal processing chain. In particular greater efficiency is made possible by more closely integrating the output of the signal processing chain and the sub band filters that are used in many audio coders. SBC, the Bluetooth default coder for music is of this type, for example.

In a filter-bank system, the delay is determined by the input and output buffers which, in turn is dependent upon the number of sub-bands. Half of the delay comes on the input and other half comes on the final output when the data is sent one sample at a time to the DAC. One key aspect of this approach is to make sure that additional delay is introduced only by the radio link and to minimize the delay due to serialization for the radio link.

Note that the SBC codec is a subband based algorithm with block based ADPCM coding of the subband outputs. By making an entire buffer available—the output of the IFFT—the SBC has enough data to begin processing. The normal delay of waiting for a sufficient number of samples is bypassed.

Processing efficiency is possible by converting from the oversampled complex frequency domain of the FFT to the subband filters of many coder algorithms. The A2DP SBC codec is one option.

Adaptive Delta Pulse Coded Modulation (ADPCM), when implemented with backward prediction is a 0 ms delay codec. Early versions were implemented for compressing telephone calls from 64 kbps to 32 kbps. To achieve greater bandwidth than the 3.2 kHz bandwidth of the phone network, filter banks were developed to break the desired frequency range into smaller bands and then using ADPCM to code the output of each of the bands. Note that there is no requirement that the same number of bits are required to code each sub band.

As digital signal processing chips become more powerful, several main techniques were used to improve quality and compression. They included: 1) more sub bands, 2) use of pycho-acoustic models both to better match the bands to the critical bands of human hearing and to use masking principles to hide the noise, and 3) more sophisticated quantization, and 4) bit coding to whiten the output bit stream. The MPEG codecs, of which MP3 is the most popular, are well known examples of this type of codec.

Bluetooth Delay Analysis:

The signal processing chain does analysis using the overlap-add method and processes 256 samples into 256 frequency bins. With 75% overlap, 64 of the output bits are valid after every overlap add execution (aka one cycle through the signal chain). The delay from input of 256 samples to 64 bit output samples, at 44.1 KHz is 5.8 ms plus the processing time. The processing time is under 0.1 ms, so the total processing delay is less than 5.9 ms.

The total delay includes the input and output delay of the device. An iPod Touch Gen 4 has 5.2 ms of delay for 256 samples at 44.1 KHz. This is in addition to the 256 bit delay for the processing. Thus the total delay for the microphone input to the earpiece output is 5.2+5.9=11.1 ms. If we look at the wireless case, we subtract the output delay (assume it to be ½ of 5.2 ms) and then add conversion delay, wireless transport delay and earpiece output delay. We can design the earpiece output delay to be under 1 ms.

One approach is to convert from the complex frequency domain to a real subband domain by converting from the complex frequency domain to a Modified Discrete Cosine Transform (MDCT). The MDCT uses a 50% overall and produces half the number of outputs as inputs, effectively reducing the sample rate by ½. In order to satisfy the 50% overlap, the first 32 bits will need 80 bits, or a second 64 bit output block. This adds a delay of ˜1.45 ms at 44.1 kHz.

This delay is less than the estimated system output delay. If we assume that the earpiece delay plus the MDCT delay is equal to ½ the system delay, the total wireless delay will be 11.1 ms plus the wireless transport delay.

The next question is to figure out how many valid bits (or bins if in the frequency domain) are needed for the coder to produce an output. There are two main types of coders:
1. Coders based on subband filtering and followed by a quantization and coding. The delay and most of the calculations are due to the subband.
2. Coders based on linear prediction followed by quantization and coding. The delay comes from the linear prediction. Some prediction coders, such as ADPCM can have zero delay. Pairing these coders with the signal processing chain, yields a total delay of 5.9 ms+ delay of the coder. If ADPCM is the coder, for example, the delay is under 6 ms.

Radio Link Processing:

The radio link audio processing includes coding and error prevention and recovery. The table below shows the types of packets and their corresponding delay and bit rates that are illustrative of the Bluetooth packets type that may be used for this application.

| | | | | No. Time Slots | | | |
|---|---|---|---|---|---|---|---|
| Packet Type | FEC | CRC | No. bytes/TS | 1 TS = 625 usec | Max Bit Rate | Delay | |
| HV3 (SCO_{—} | N | N | 30 | 1 every 6 (3.75 ms) | 64 kbps | 7.84 | ms |
| EV3 (eSCO) | N | Y | 30 | 1 every 4 (2.5 ms) | 96 kbps | 12.1 | ms |
| DM3 (ACL) | 2/3 | Y | 121 | 3 every 12 (3 ms) | 129.06 kbps | 17 | ms (est) |
| 2DHI (ACL) | N | N | 54 | 1 every 4 (2.5 ms) | 172.8 kbps | 17 | ms (est) |

HV3 is an SCO packet. HV3 packets are sent without options for re-transmit. EV3 is an eSCO packet. eSCO packets have a re-transmission request if the CRC indicates a problem. EV3 may be a good choice because 1) it has a re-transmit capability, 2) if we put in redundancy for packet loss, the delay would be 5 ms if we repeated each packet (note this would require compression to 48 kbps).

ACL provides several options, some of which include FEC and CRC at the expense of bandwidth. Error rates may indicate another choice.

| TS | 1 | 2 | 3 | 4 | 5 | 6 | 7 | 8 | 9 | 10 | 11 | 12 |
|---|---|---|---|---|---|---|---|---|---|---|---|---|
| HV3 | To S1 | Fr S1 | To S2 | Fr S2 | To D1 | Fr D1 | To S1 | Fr S1 | To S2 | Fr S2 | To D2 | Fr D2 |
| EV3 | To S1 | Fr S1 | To S2 | Fr S2 | To S1 | Fr S1 | To S2 | Fr S2 | To S1 | Fr S1 | To S2 | Fr S2 |
| DM3 | To S1 | To S1 | To S1 | Fr S1 | Fr S1 | Fr S1 | To S2 | To S2 | To S2 | Fr S2 | Fr S2 | Fr S2 |
| 2DHI | To S1 | Fr S1 | To S2 | Fr S2 | To S1 | Fr S1 | To S2 | Fr S2 | To S1 | Fr S1 | To S2 | Fr S2 |

For each case, there is a different approach for handling two slaves, and a small amount of data. In the case of HV3, the data will be sent in DM1 ACL packets. In the case of EV3 and DM3, the data bits will be packed with the voice bits, so the effective data rate will be somewhat less than ideal rate. The data rate is expected to be low enough that the audio bit rate for EV3 will be over 90 kbps.

Exemplary Implementation:

The following are exemplary project specifications that were established for one exemplary implementation of a low latency wireless Bluetooth protocol:

1. Audio Quality
Audio that will be sent over the wireless link from the signal processing chain bandwidth limited to 8 kHz. The dynamic range is muted by the broadband AGC.

2. Compression Ratio/Bit Rates
Delay can be added into the system when buffers are serialized. This implies that fitting a frame of data into one or, at most two, packets is advantageous. Based on the data above, a bit rate of about 95,500 bps would yield the lowest delay (including overhead for error recovery/mitigation).

3. Low Latency
Under 2 ms or so including error resilience is the target.

4. Bit Error Resilience
Wireless communications links have particular levels of susceptibility with respect to increasing range, interference from other devices and the effects of multipath propagation. The audio codec has a role to play in terms of tolerance to bit errors and recovery from longer-term data loss. For high-quality digital wireless microphones the maximum allowable time for the audio decoder to re-synchronize to the data stream after longer-term data loss is of the order of 3 ms. Notes: AMR uses information about the channel to determine bit rate. See also paper to use jitter buffer info to adjust the encoding and decoding, loss concealment, etc.

The exemplary implementation leverages the sub-band structure of the signal processing chain to produce a sub-band coder for the wireless link. In particular the complex frequency representation is converted into a real modified cosine transform sub-band representation. Then the sub-band outputs were quantized and coded. This includes, conversion from a complex FFT to a Modified Cosine Transform as well as sample rate conversion to convert the over-sampled filterbank to a rate that matches the Bluetooth link. The bit rate=frame rate*number of bands* number of bits/band. For 8 KHz at 44.1 k samples/sec and 256 bin frames, only 46 bands have data worth sending. The frame rate, if critically samples is 44.1 Khz/256=172. 25% overlap/add means the frame rate is 689 frames/sec. 95500 bps at 689 frames/sec and 46 bins/frame is just over 3 bits per bin. There are a couple of different quantization approaches to choose from, e.g., G.726 standard ADPCM quantizer, improved ADPCM quantizer with enhanced prediction and possibly psych acoustic enhancement, range based quantization with energy and shape quantization and the like.

With respect to bit-level coding it is important to note that because SBC combines several output vectors which may add latency, the key is not to combine successive frames.

Additional Disclosure Relating to Exemplary Embodiments:

A mobile application, as disclosed, may be configured to receive sound input from a microphone or a transmitted source, processes the sound input and outputs the processed sound to an earpiece or speaker. Alternately, the mobile application may take input sound from a transmitted source such as, but not limited to, a mobile telephone call, to improve the clarity of speech received from that source.

In exemplary embodiments, a mobile device may be used as a recording device, e.g., for recording conversations in a noisy environment and then applying signal processing techniques to make the recorded speech clearer, or to change the spoken speed to be faster or slower.

The embodiments of presented herein may have many other uses. For example, the application may be useful in assisting a user to listen to sound from any transmitted source, such as sound produced from multimedia files, sound streamed over the web, sound from “landline” phones, sound from a television.

In exemplary embodiments, wireless earpieces make use of new low cost, low power, and small size consumer wireless components as feedback issued are removed since the microphone may be not close to the speaker

By integrating the hearing-assist technology with mobile-devices such as Smartphones and Tablets, hearing-assist functionality becomes a valuable fully integrated feature of a mobile computing device, e.g., phone, as opposed to a specialized a medical device. This, may help reduce or eliminate the stigma associated with using a hearing aid.

Exemplary embodiments not only benefit those with hearing loss, but may be valuable to users who do not have hearing loss but desire the additional hearing support in noisy environments or the intimate, unobtrusive connection to their mobile-device.

In the hearing aid marketplace there are thousands of dollars' difference between the lower-end devices (that mainly do DRC and frequency-based amplification and very little in noise reduction), and the high end devices that have all of these features. The embodiment of the invention delivers comparable high end algorithms while adding its own valuable unique features. Because of its low cost, the power of the hearing Signal Processing algorithms will have a dramatic effect on the broad availability of hearing assistance.

In exemplary embodiments, the systems and methods of the present disclosure may improve the hearing of those with a hearing loss measured from slight to moderate/severe. In particular, the present disclosure focuses on innovations that improve speech clarity, especially speech clarity in a noisy environment. An important problem with hearing loss is the lessened ability to comprehend the targeted speech of a speaker to whom one is listening. The disclosed innovations are also situationally useful to those with no measurable hearing loss, as the innovations improve speech clarity in noisy environments where even those with no hearing loss may have difficulty understanding a targeted speaker, such as at a concert, or in a noisy train.

Mobile devices offer many standard features that can be used to support hearing assistance. For example, one feature is the availability of real-time control by a user either through the physical interface of a touch screen or keyboard or real time control through the audio channel. Mobile devices may include a number of user controls that are not available to users of current hearing aids. Another capability usually offered in mobile-devices is connection to the Internet.

As noted above, DSP is typically performed utilizing a stand utilizing a standard operating environment of a commercially available mobile platform, and utilizing the multipurpose programmable central processing unit and a multipurpose programmable digital signal processor contained in the mobile device. The hardware and operating environment utilized for DSP is not of a dedicated hearing aid device but rather of a mobile computing device. DSP is typically implemented by way of an application which may be stored and executed, e.g., without changing the underlying firmware of the device. The application may be upgradable and may be utilized with any number of different mobile devices. Thus, the systems and methods of the present disclosure free the software for DSP from having to be employed in a dedicated hardware platform/environment.

Innovations may be implemented, which utilize mobile-devices, to execute applications that may run on mobile-devices to provide a hearing assistance device. The application may run on the standard operating systems for these commercial mobile-devices. In alternative embodiments, DSP may be performed partially or wholly utilizing a proprietary hardware component which operatively associates with a mobile device. This type of implementation however may restrict portability and upgrade-ability, as well as make cross platform use (e.g., with different mobile devices, difficult. If the application interfaces with a standard operating environment, then the embodiment of the invention may be usable on all devices that utilize the operating system and its supporting chipset. Because of the maintenance of compatibility at the system level, it also means that versioning the application may be possible.

The cost barrier may be reduced by utilizing the processing power in an already paid for mobile-device and by utilizing the mobile-device's microphone. Such a configuration enables the use of low-cost consumer electronics components. This drives down production costs, thus driving down the price to the consumer.

By addressing all levels of the mobile-device's software/firmware stack, the embodiment produces complete and sophisticated hearing assist signal processing components that can run on the dedicated circuitry of the mobile chips, or specialized software modules similar to those supporting video and image processing. To make these hearing assist components ubiquitous, they are designed to run on multiple platforms and to be easy to implement. In exemplary embodiments open source API stacks are used. However some embodiments of the invention include hardware specific coding to ensure the processing efficiency that is required to reduce latency.

In exemplary embodiments, standard consumer electronic components are used rather than specialized hearing aid components.

Also exemplary embodiments utilize the chips already in a Mobile device, such as a smartphone or tablet, so no extra hardware costs are incurred.

In exemplary embodiments, the systems and methods of the present disclosure implement an application, e.g., software and potentially firmware, with distinct versions tailored to run on the standard operating system of a particular product-family of mobile-devices, e.g., Smartphones, cell phones, tablets or PDA devices

Software that runs in the standard operating environment of commercially available Mobile Platforms. Examples of these operating systems are: iOS for Apple's iPhone/iTouch/iPad product line; Android by Google utilized by many Smartphones, tablets and other Mobile Platforms; and Windows Mobile by Microsoft. In addition the operating environment includes low level routines called by the operating environment such as device drivers and the firmware that may be used in supporting chipsets, which are core components of the commercially available Mobile Platform.

In exemplary embodiments real-time processing may be facilitated using kernel level coding. Kernel processing may be available for open operating systems, e.g., Android, which is based on Linux, provides an accessible kernel program in the context of a multipurpose programmable operating system.

The environment of a Smartphone, may be quite complicated. While it is an embedded processor, it has aspects of desktop machines that impede real-time processing. Linux and/or other UNIX derivatives are the core of the operating systems running on the majority of the Smartphones and tablets in the market today. Obtaining real-time performance in these environments has usually been achieved to some extent by a combination of approaches such as locking critical code, taking advantage of multi-core processing, and process/thread priority management. The underlying commercial chips in Smartphones have also added specialized hardware such as:
Single Instruction/Multiple Data (SIMD) instructions for signal processing.
Separate data and instruction caches
Higher clock rates and multi-core chips.
DMA transfers data from main memory to the caches.

Taking advantage of these capabilities, both in hardware and in the OS, often requires optimization of low level code (kernel not user level), frequently written in assembly language. Development of the code is expensive and time consuming for integration and programming. For closed OS, special access may is often required to access the kernel. Supporting multiple platforms requires it to be done separately for each hardware platform.

For example, Texas Instruments has a multi-media framework and multi-media software that use the specialized signal processing blocks that reside outside of the high level OS.

In exemplary embodiments, the systems and methods disclosed herein are configured such that the aggregate latency between when the ambient sound is received at the microphone and converted to sound in a speaker is such that a listener does not perceive an echo between the ambient sound reaching the listener's ear and the processed sound delivered from the listener's earpiece, (for example, aggregate latency <40 ms, <25 ms or <20 ms)

Limitation related to “aggregate delay” or “aggregate latency” as used herein relate to the perceptibility of an echo-like effect by a user. Different delay periods which may contribute to aggregate delay were previously discussed.

The systems and methods of the present disclosure provide for effective speech/sound processing and noise reduction processing in real-time, e.g., within an acceptable latency period. (Throughout the present disclosure, acceptable latency period, near real-time and real-time are used interchangeably to mean within the bounds where the brain will integrate sound processed on the hearing assistance platform with ambient sound directly reaching a user's ears through the air such that there may be no echo effect between the processed sound and the ambient sound.) This innovation may be implemented, inter alia, by creating, selecting or modifying a set of speech detection and noise reduction algorithms so in aggregate they will execute within the acceptable latency period.

In exemplary embodiments, DSP may be performed within a time constraint such that the brain can integrate the processed sound with the ambient sound directly coming to the ear. Thus, a user does not hear an annoying echo. This time constraint is best if it is around 20 ms or 25 ms. However a total time constraint up to around 40 ms may be tolerable by most people. To accomplish the time constraint, an exemplary embodiments of the systems and methods of the present disclosure implement novel algorithms, for example, for speech detection, and, in some cases innovative modifications of existing software algorithms.

Exemplary embodiments include various algorithms such that the microphone to speaker latency may be targeted at less than 20 ms or 25 ms and in some cases no more than 40 ms. The time constraint requires innovative use of existing algorithms for aspects of speech detection, speech clarification, noise suppression, noise control, and noise reduction. The processing constraint also requires the embodiment of new algorithms for aspects of speech detection, speech clarification, noise suppression, noise control, and noise reduction.

In order for the invention to deliver on its promise, the embodiment of the invention deals with specific challenges of implementing hearing-assist signal processing on Mobile Platforms. The primary challenge is processing latency, as the time delay may not exceed about 40 ms between when ambient sound reaches the ear and when the sound processed by the embodiment of the invention reaches the air. The conviction that the invention may deal with this challenge was first based on the observation that many mobile-devices have sophisticated video and image processing subsystems, enhanced instructions, and/or multiple processors so that they have the basic computational power to support the required specialized computation load. And given Moore's law, which is certainly being followed in the mobile-device space, these devices may be able to support processing that may continue to evolve in complexity. The second observation to support the conviction that exemplary embodiments may be successful, is that APIs to access and control the signal processing and flow of the I/O may be developed at all levels of the software/firmware stack.

This approach takes inspiration from audio solutions that have been implemented to take advantage of the specialized signal processing capabilities for features such as stereo widening, psychoacoustic enhanced bass, and echo cancellation, provided by companies such as Ittiam. The key difference may be that those processing components are not delay critical. If there are 100 ms of delay at the start of playback of a music file, it does not affect the user. Multi-media applications including telephone calls are processing delay insensitive because there is no competing ambient sound to synchronize. Hearing assistance has to compete with the ambient sound, which is being sampled by the microphone, directly reaching the listener's ears much sooner than the processed sound. Commercial hearing aids have delays under 5 ms. This embodiment of the invention does not meet that metric but keeps the total delay to below 40 ms—including the delay of the radio link—which has been cited as the threshold for audio that appears to be lip synchronized to video. The hypothesis is that 40 ms is the absolute worst case.

Exemplary embodiments have a target delay at 10-15 ms for all signal processing (ADC, DSP and DAC) for two reasons: 1) It is generous compared to the delays of hearing aids, and 2) To allow for a delay in a communication link. Radio Frequency (RF) chips for streaming audio have the ability to trade off delay for reliable transfer. Thus, a digital radio link may add 15 to 20 ms of delay.

The environment of a mobile-device, however, is much more complicated. While it is an embedded processor, it has aspects of desktop machines that impede real-time processing. Linux and/or other UNIX derivatives are the core of the operating systems running on the majority of the mobile-devices and tablets in the market today. Obtaining real-time performance in these environments has usually been achieved to some extent by a combination of approaches such as locking critical code, taking advantage of multi-core processing, and process/thread priority management. The underlying commercial chips in mobile-devices have also added specialized hardware such as:
Single Instruction/Multiple Data (SIMD) instructions for signal processing.
Separate data and instruction caches
Higher clock rates and multi-core chips.
DMA transfers data from main memory to the caches.

Taking advantage of these capabilities, both in hardware and in the OS, often requires optimization of low level code (kernel not user level), frequently written in assembly language. Development of the code is expensive and time consuming for integration and programming. For closed OS, special access may be required. Supporting multiple platforms requires it to be done separately for each hardware platform.

For example, Texas Instruments has a multi-media framework and multi-media software that use the specialized signal processing blocks that reside outside of the high level OS.

Texas Instruments and Qualcomm have a number of development kits for different processors, each of which is used in commercial mobile-device and/or tablet devices. These development kits provide access to all of the layers shown in the diagram. Exemplary embodiments focus on utilizing TI or Qualcomm chips, which are used in low-cost mobile-devices, where the software/firmware can be easily developed and tested.

Mobile-device chips continue to improve, with newer, more powerful processors as well as multi-core implementations. Thus, exemplary embodiments may employ a dual-core Advanced Risk Machine (ARM) solution with enhanced instructions for signal processing such as offered by Qualcomm.

In addition to minimizing delay as much as possible, there are several mitigation effects and strategies that can be implemented. In loud environments, the echo effect may not be perceptible and therefore aggregate delay may not be a problem. If the direct speech can't be heard then it's unlikely the echo will be either. Thus, the systems and methods of the subject application may provide for a more lenient delay and allow for more involved DSP in loud environments (loud environments may require additional noise suppression and isolation algorithms and which may require further processing time). Time delay constrictions may be relaxed or suspended depending on the environment. Earpieces can provide passive noise suppression. Earbuds in particular are good at blocking/suppressing interfering sounds at the ear. In exemplary embodiments the systems and methods of the subject application may detect what type of speaker, e.g., what type of earbud is being employed. The type of speaker may be utilized in DSP to better process the signal for optimal output to the particular type of speaker being utilized. Time delay constrictions may be relaxed or suspended depending on the type of speaker being utilized. The wireless earpiece may also be capable of active noise cancellation because it will have one or more mics normally used for a telephone call. Time delay constrictions may be relaxed or suspended depending on the use of active noise cancellation. Experience from other industries suggests that delay or echo can be adapted to over time. Time delay constrictions may be relaxed or suspended depending on acclimatization.

The Signal Processing Algorithms utilized by the systems and methods of the subject application may fit into four main categories that combine to provide robust hearing compensation:

Speech detection—One feature of DSP is the ability to detect speech versus noise. Once speech may be detected many actions can follow such as killing all sound when no speech is being heard producing an effect of s much less noisy environment, taking actions to reduce noise in speech such as removing any loud clattering sound, enhancing certain frequencies that will make speech or parts of speech clearer, etc.

Speech intelligence—DSP may include dynamic range compression (DRC), frequency-based amplification (comparable to an audio equalizer, directional microphones, and speech enhancement such as formant boosting).

Sound quality—DSP may include employing algorithms related to improving sound quality. Important aspects of sound quality may include: a) wideband (at least 6 kHz), b) low group delay in the processing (under 2 ms), which is particularly challenging in the mobile-device environment, and c) feedback cancellation.

Noise reduction—There are many types of noise, and it may be critical to be able to distinguish speech from noise; e.g. a) wind, b) impulse—prevent audio shock, requires activity within 1 ms of onset, c) environmental which can be many things including busy streets, restaurant conversations, train noise, etc. This is one of the biggest causes of dissatisfaction with hearing aid owners. Given the speech detection trigger multiple noise reduction algorithms are utilized.

In exemplary embodiments, DSP may include, e.g.:
Frequency based hearing loss gain compensation
Dynamic range compression with volume and balance control
Noise removal
Speech enhancement for intelligibility
Hardware acoustic compensation
Active noise cancellation (in the earpiece)
Low delay audio coding for wireless link

In exemplary embodiments DSP may be performed on a real-time or high priority thread of the chip. APIs may also be utilized to access DSP abilities of a CPU.

In exemplary embodiments, a component of aggregate latency contributed by the digital signal processing is reduced by executing the audio processing on the real-time or highest priority thread of the multipurpose programmable digital signal processor.

The sound signal then may be transmitted to a mobile-device either, which may be running the Application. The signal may be converted from an analog to digital signal utilizing the DSP chip in the processor device. Based on a set of set parameters, the received sound may be processed using digital filtering and signal processing technology. The processing may involve changing the gain of various frequencies; then performing noise reduction to reduce unwanted background noise, improving speech clarity and strengthen the speech-to-noise ratio, by triggering off an efficient voice activity detection algorithm. In exemplary embodiments, all a processing of the sound signal may be done in less than 25 ms.

In exemplary embodiments, a component of aggregate latency contributed by the digital signal processing is reduced by managing the frame buffer size and sampling rate so as to minimize processing delay.

The input sample rate, may be 11.025 kHz rather than the 44.1 kHz used in the model. This produces a speech bandwidth of about 5 kHz, and reduces the amount of computation. This will reduce the size of the filter bank from 256 to 64 bands, with the same framing rate of 5.8 ms.

Achieving low latency may involve careful management of buffer sizes and interrupt rates. The minimum buffer size is the size of the overlap in the FFT calculation to create the filter bank. While the drawing shows a bit rate of 44.1 KHz, typical bit rates in the preferred embodiment may be 22.05, and 11.025 KHz, resulting in 128 and 64 filter bands instead of the 256 shown. A 75% overlap leads to a minimum interrupt period of 1.45 ms.

In exemplary embodiments, a component of aggregate latency contributed by the digital signal processing may be reduced by executing algorithms for the digital signal processing, where the algorithms are driven by parametric input, such that the aggregate time to execute all algorithms is under 4 ms, where the digital signal processing algorithms include, but are not limited to, gain control and gain shaping, frequency gain adjustment, frequency mapping, dynamic range compression, noise suppression, noise removal, speech detection, speech enhancement, detection and suppression of non-speech impulse sound.

Exemplary embodiments may implement dynamic range compression and include the capability to limit loud, impulsive sounds.

In some embodiments an audio coder may be used which includes a very low delay, ideally less than 1 ms. This eliminates block based coders. Sub-channel implementations of ADPCM are the leading candidates. For example, a 64 kbs rate can carry two sub-bands of 32 kbps ADPCM which is sufficient to carry 5 kHz to 8 kHz audio bandwidth at an overall rate of 64 kbps.

In exemplary embodiments, coding for error recovery at both the bit and packet level may be utilized, e.g., provided that the delay is minimal; processing delay target, per frame of data, (not including framing time) ideally under 2 ms.

Various enhancements, based on recent advances, may also be implemented and evaluated, including:
Low delay architectures
Modification to improve the trade-off between intelligibility and noise comfort.
AGC/Compression algorithm enhancements
Understanding of how the signals are changed due to the non-linear effects of the ear.
Algorithms for specific types of noise, e.g. wind, impulse, etc.
Additional information provided by the user via the apps UI.

In exemplary embodiments, an aggregate latency may be reduced by processing the audio signal utilizing a filter bank where the filter bank signal processing has a group delay variance across frequencies of under 2 ms, such that the signal processing is responsive to the frequency distribution of the source sound, including the target source sound and accompanying noise, and controlled by the parameters of a composite profile comprised of, but not limited to, a basic hearing loss profile, a personal equalization profile, and a noise profile.

The algorithm may be based on a filter bank architecture. One modification is to move to a perceptually relevant frequency resolution (e.g., the critical band (in Bark), or the ERB scale).

Exemplary embodiments may implement gain management features, including:

Gain calculation—Looking at the gain error, limiting the max change in gain under certain circumstances.

Dynamic range compression—includes the capability to limit loud, impulsive sounds

Safety limits—levels based on medically accepted standards,

One exemplary implementation may be a multi-band frequency based compressor. Other embodiments are possible that provide time-domain based compression. Some enhancements may include:
Using warped frequency bands, similar to enhancement in noise removal.
AGC to control the max output signal, and may be statistically optimized.
User controls to turn compression off, for linear gain for watching TV and listening to music.
Two levels of AGC/Dynamic Range Compression. One fast acting to provide protection of loud sounds.

In exemplar embodiments, noise suppression may be implemented such that not all noise in between the targeted speech sound is suppressed, e.g., especially between words. The brain mostly hears noise when it is not listening to and processing the actual targeted speech. By suppressing noise outside of speech sound, the brain perceives a quiet environment and is happier.

In exemplary embodiments, dynamic adaptive control may be implemented based on changes in the noise environment and in the targeted speech. This innovation can be implemented by monitoring the background noise. As the noise level changes, various noises suppression controls are changed.

The speech-to-noise ratio is the energy ratio of the targeted speech to all other sound. e.g., the noise. In some embodiments the ambient speech-to-noise ratio may be monitored in real time and used to affect various controls.

For example, the Application may spend some time “listening” to the background noise in a particular location and dynamically apply filter parameters to reduce the effect of that learned noise. Additional processing may include a second level compressor for complete protection against impulsive sounds.

In some embodiments, techniques may be used for detecting and controlling noise within the voice band of the targeted speakers. For example, given the comb pattern of speech, the innovation can recognize other sound (noise) within the voice band and reduce its effect

There are many types of noise, and it is important to be able to distinguish speech from noise. Multiple noise reduction algorithms may be utilized either alone or in combination depending on the situation. Exemplary noise removal algorithms described herein are based on a Weiner filter that has been shown to have a good combination of noise suppression, speech intelligibility, and low complexity in terms of computation. The initial implementation is a basic Wiener/Spectral Shaping algorithm with Dynamic Range Compression, and per-ear frequency based gain compensation. Other approaches to noise reduction include “modulation frequency” used in many hearing aids, and comb filtering/coherent modulation and auditory scene analysis. These alternatives may be considered only if adequate performance cannot be achieved with the filtering approach.

The signal processing may recognize background noise as distinct from targeted speech, through voice-activity-detection that relies on features of speech such as the sound spectrum of speech, and/or statistical means that indicate a likelihood of speech detection, and to reduce the effect of noise interfering with the targeted speech.

In exemplary embodiments, the aggregate latency may be reduced by forgoing the need to analyze a signal in the frequency domain (e.g., by performing a Fourier transform). Thus, in exemplary embodiments, DSP may include dividing the audio signal, at regular intervals reflecting the acceptable latency, into two frames, a small frame and large frame where an energy parameter (E) is calculated by frequency from the small frame and the calculated energy (E) is used to detect a start-point and endpoint of audio that is identified as speech and initially identified in the speech mode and where a pitch period (P) is detected and measured from the large frame and the pitch detection is used to determine whether there is voiced speech to validate that the audio is speech and may be identified as speech mode.

In exemplary embodiments, both time and frequency domain speech detection may be utilized, e.g, processed on separate strings. A processed secondary string may be utilized to calculate parameters as inputs to the main DSP process, when there is targeted speech.

In some embodiments a target speaker's speech may be recognized and separated from other sound. In particular, even recognizing the target speech when it starts and stops between spoken words.

One need for anyone with slight to moderate hearing loss is speech intelligibility. Even listeners with normal hearing can have difficulty understanding speech in a very noisy environment. Hearing assistance products such as hearing aids and Personal Amplification traditionally have some deficiencies in terms of speech clarity because of their limited ability to detect speech. A hearing device is turned on all the time and the microphone is very sensitive, background noise such as street traffic, wind, car engine, music/TV show in restaurant is often actually amplified and can be very annoying and distracting. One reason that most hearing assistance devices do not do a good job detecting speech is the hardware, software complexity of speech detection, including the speech detection algorithms.

Some embodiments may manage music listening or TV watching and targeted speech listening seamlessly. This is implemented by allowing the user to enjoy music or TV sound but modifying the sound profile when targeted speech is recognized so that the user is instantly aware and clearly hears targeted speech

Since speech generally concentrates in 400 Hz to 3000 Hz spectrum, channel based ener-gies, instead of the total energy, of each short time frame may be used to further improve speech detection reliability.

Once speech is detected many actions can follow such as suppressing all sound when no speech is detected, producing an effect of a much less noisy environment, taking actions to reduce noise in speech such as removing any loud clattering sound, enhancing certain frequencies that will make speech or parts of speech clearer, etc.

In some embodiments, speech may be enhanced, e.g., by moving speech to a lower frequency and formant emphasis. In example embodiments processed speech may be supplemented with overtones to make speech sound more natural.

Frequency transformations can be implemented by, for example, the suppression of noise in particular frequencies and transformation of speech sound from other frequencies to the suppressed frequency. In many cases, those with moderate hearing loss can hear lower frequencies, usually occupied by noise, and not hear higher frequencies where speech occurs, so speech frequencies can be lowered to lower frequencies where noise has been suppressed. Additional processing may include dereverberation and/or additional speech enhancements such as formant emphasis and pitch shifting.

In exemplary embodiments DSP may be controlled by passing a set of parameters to the digital signal processor, where a parameter is derived from an entry into the mobile device user interface, or derived from characteristics of the ambient sound, or derived from data persistently stored on the mobile device, or derived from the execution of an algorithm.

Non-real-time, ongoing analysis of speech and noise (analysis of sound frames greater than 40 ms), as received from the Primary Microphone and the contained Earpiece microphones may also be utilized. This analysis may be used, e.g., for establishing the level and profile of environmental background noise, discerning the direction from which the targeted speech is coming and/or identifying an audio profile of the targeted speech.

In exemplary embodiments a set parameters may be passed to the digital signal processor that define a hearing profile descriptor, where a hearing profile descriptor is retrieved from persistent storage on the mobile device, or is entered from the mobile device user interface, or is modified from an existing hearing profile descriptor.

Profile descriptors may be included for pre-stored profiles, edited profiles, audiogram entry, internal hearing test, stored and retrieved profiles. Recording sound, may be replayed to facilitate choosing or refine a profile.

Example embodiments may utilize the standard capabilities and storage offered on the a mobile-devices to implement the recording of sound and speech on the mobile-device's local storage, thereby allowing the recorded speech to be replayed so a user may improve profiles for general hearing or for refining the profile for noise control in an environment or the profile of targeted speaker.

For example, the DSP application may present the user with a frequency-profiling tool that may allow the user to define and store personal frequency profiles. The basic profile can then be combined with user preferences to define usable labeled personal profiles for various situations. For example, a core basic profile may be created in a quiet environment but additional basic profiles may also be constructed, in real-time, for various environmental situations and also for particular targeted speakers or classes of speakers. A user may want a different profile for listening to a female voice vs. a male voice. A user may want a specific basic profile tuned their spouse. Saved personal profile, once created, may be used when the user is in the targeted environment. An embodiment may also come with pre-stored profile for various situations, e.g., a close conversation, presentations in a large hall. These pre-stored profiles may be directly utilized or may be a starting point for a user to create a customized profile.

Multiple profiles can be set in real world settings that optimize the sound processing for that setting. Profiles can be saved and restored. In exemplary embodiments, a basic hearing test may be employed so that users can create a profile that adjusts for their general hearing loss. But more importantly profiles can be made specific for particular situations such as a profile that may be tuned to clearly hearing one's spouse's voice in a noisy environment

Associated with the Profile-builder, a basic hearing test facility is included to allow the user to create base-line profiles that indicate corrections to “normal” hearing levels in different environments.

Left and right ear frequency based gain modification may be based on a combination of per ear hearing profile and a “graphic equalizer” input from the UI that is common to both ears.

Exemplary embodiments also implement algorithms to input an audiogram from a hearing test taken elsewhere, to select a hearing loss profile based on demographic data, and to modify an existing hearing loss profile.

Standard electronic representations of audiograms may be available and may be transferred to the mobile phone via a download process, either wired or wirelessly.

Exemplary embodiments include utilizing hearing loss profiles based on demographics, e.g., profiles based on 5 year groupings for male and female. Note that both larger and smaller ranges of groupings may be used. The primary benefit of demographic based hearing loss profiles is convenience—a first approximation to a user's hearing loss; particularly if they have light to moderate loss can be quickly selected and put into use without going through a hearing test.

The speech intelligibility aspect of a hearing test may be accomplished by playing words at various levels of sound and noise. The processor may take information from the speech test to enhance and/or modify the basic hearing profile.

In exemplary embodiments, a set parameters may be passed to the digital signal processor that define an equalizer profile descriptor, where an equalizer profile defines a set of user preferences that modify the hearing profile; where an equalizer profile descriptor is retrieved from persistent storage on the mobile device, or is entered from the mobile device user interface, or is modified from an existing equalizer profile descriptor.

An equalizer profile may generally relate to hearing preferences whereas a hearing profile is typically related to the hearing abilities of the user.

In some embodiments the frequency equalization profile may be automatically adjusted to improve speech clarity. This innovation can be implemented by analyzing the sound input in a background process, and, for example, changing the frequency profile if the source of targeted speech changes from a man speaking to a woman speaking.

Profiles may also be created for targeted speakers such as a user's spouse or business colleague. These profiles may be saved on the local storage of the mobile-device. Then these profiles may be reloaded if the user wished to re-institute the settings for that environment so that the individual parameters may not have to be re-entered by the user.

In particular, a base profile may be created utilizing a capability in the application that simulates a basic frequency hearing test. This may be implemented by having the user recognizing whether they can hear a sound of a certain frequency and depreciating gain on frequency until it cannot be heard.

Also, automated changes in the in frequency gain profile are made as the source of targeted speech changes, e.g., from a man speaking to a woman speaking

In example embodiments sound volume can be automatically adjusted to a preferred level selected by the user. For example, this is implemented by allowing users to select a volume that is most comfortable with the sound played. Then a signal strength level is calculated according to the selected volume and the prerecorded sound to serve as a reference to adjust, automatically, volume for real-time sound input.

Exemplary equalization features may include, e.g., activating and utilizing stored equalization profiles, creating composite equalization profiles based on one or more stored profiles and the frequency distribution of the source audio digital signal, and/or creating composite equalization profiles based on one or more stored profiles and the noise profile of the source audio digital signal.

Some important aspects of sound quality include: (i) wideband (at least 6 kHz), (ii) low group delay variance across frequency in the processing (under 2 ms) and (iii) feedback cancellation.

Exemplary embodiments may utilize a multi-band frequency based compressor. Other embodiments, however, are also possible that provide time-domain based compression. Exemplary embodiments may also include using warped frequency bands, AGC to control the max output signal (may be statistically optimized), User controls to turn compression off, for linear gain for watching TV and listening to music, two levels of AGC/Dynamic Range Compression. One fast acting to provide protection of loud sounds.

Left and right ear frequency based gain modification may be based on a combination of per ear hearing profile and a “graphic equalizer” input from the UI that is common to both ears.

Multiple profiles can be set in real world settings that optimize the sound processing for that setting. Profiles can be saved and reinstituted. Importantly profiles can be made specific for particular situations such as a profile that may be tuned to clearly hearing one's spouse's voice in a noisy environment.

The hearing loss profile can then be combined with user preferences (e.g. equalizer settings), and an adjustment profiles environment profiles, and source profiles to define useable labeled aggregate profiles for various situations. For example, a core adjustment profile can be created in a quiet environment but additional adjustment profiles can also be constructed, in real-time, for various environmental situations and also for particular targeted speakers or classes of speakers. A user may want a different situational adjustment profile for listening to a female voice vs. a male voice. A user may want a specific adjustment profile tuned to their spouse. The saved personal adjustment profile, once created, can be retrieved and used when the user is in the targeted environment.

Exemplary embodiments may also utilize pre-stored adjustment profiles for various situations, e.g., a close conversation, presentations in a large hall. These pre-stored profiles may be directly utilized or may be a starting point for a user to create a customized profile, for example with particular targeted speakers or classes of speakers

In exemplary embodiments, a set parameters may be passed to the digital signal processor that defines a noise profile descriptor, where the noise profile descriptor is computed from processing ambient noise for a period of time when the targeted sound is not present; or the noise profile descriptor is retrieved from the mobile device persistent store; or the noise profile descriptor indicates that the digital signal processor may estimate a noise through the use of a speech/noise estimation algorithm.

Some embodiments may implement the real time creation and storage of audio profiles for environments and/or targeted speakers, e.g., the creation of the profile while still within the noise environment or listening to a targeted speaker. Profiles may be implemented for very specific noise environments, such as a user's car.

Exemplary embodiments may provide dynamic adaptive control based on changes in the noise environment and in the targeted speech. For example, this may implemented by monitoring the background noise. As the noise level changes, various noises suppression controls are changed.

Some embodiments may include enabling the primary microphone of the smartphone and recording the background noise in a particular location. One result may be to dynamically apply filter parameters to reduce the effect of that learned noise. Another may be to recognize the frequencies of a speaker, and increase the gain of those frequencies and reduce the gain in surrounding frequencies to reduced noise. Another may be to distinguish background noise from voice and suppress background noise.

In addition to the primary processing of sound in real time, the Application may perform different background analyses that examine the sound input over seconds and that provide information to set or reset controls that will improve speech clarity

Exemplary embodiments may include UI (User Interface) means to create and store, in real time, adjustment profiles for environments and/or targeted speakers, e.g., the creation of the profile while still within the noise environment or listening to a targeted speaker. Adjustment Profiles can be implemented for very specific noise environments, such as a user's car. Profiles can also be created for targeted speakers such as a user's spouse or business colleague. These profiles can be saved on the local storage of the Mobile Platform. Then these profiles may be reloaded if the user wished to re-institute the settings for that environment so that the individual parameters may not have to be re-entered by the user.

In exemplary embodiments, a set parameters may be passed to the digital signal processor that provide settings that limit the allowed upper limit of gain and the reduction of gain for loud non-speech impulse sound. May be set based on total power relative. Dynamic range may be reduced, such that loud parts are softer and soft parts louder.

Volume control may also be used to adjust the overall gain to set the sound volume to a preferred level selected by the user regardless of the loudness of the spoken speech.

In some embodiments, sound volume may be automatically adjusted to a preferred level selected by the user. This can be implemented by allowing users to select a volume based on a signal strength level utilizing a prerecorded sound to serve as a reference. Then using the selected sound level to influence the gain for the real-time sound input.

In exemplary embodiments, a component of aggregate latency contributed by the wireless transmission of the processed audio may be reduced by executing a buffer algorithm that minimizes delay.

In exemplary embodiments, a component of aggregate latency contributed by the wireless transmission of the processed audio from the mobile device to an earpiece is reduced by executing the transmission through a dongle attached to the mobile device where the transmission algorithm has low latency such as, but not limited to, an FM broadcast, or a modified Bluetooth protocol transmission.

Exemplary embodiments may use of short-range wireless connectivity between the headset and mobile-device, for example, the use of the, digital FM connectivity or FM analog transmission.

The dongle may also contain a T-coil so it can receive induction signals produced in many environments, to support those with a hearing loss, environments such as theatres, lecture halls, information booths, etc.

In another embodiments, low cost FM transmission chips or low cost commercial DSP chips can be integrated into the dongle of the mobile-device to perform the necessary processing.

In exemplary embodiments, an algorithm may be employed to adjust for sound and frequency differences between different earpieces. The earpiece may also include an attached or embedded microphone which may provide secondary audio information to the DSP process, e.g., that the listener is talking, any local noise conditions. The microphone may also be used to characterize a particular earpiece.

In example embodiments, sophisticated hearing-assist algorithms run on the mobile-device and connect to discrete, behind-the-ear (BTE) earpiece that connect via a low-latency wireless link.

Other embodiments utilizes a wireless set of earpieces such as a Behind-the-Ear (BTE) earpiece. By providing a BTE option, the cultural stigma associated with hearing loss is reduced as their use may be very unobtrusive. Adding telephone and music playback functionality further reduces stigma because the earpiece is not seen as a sign of old age.

In example embodiments earpieces and headsets may include support of a low delay, bi-directional wireless protocol such as described herein. In example embodiments, companding may be implemented to improve the dynamic range of the coder in a wireless link. Exemplary embodiments may enable migrating some of the speech enhancement signal processing to the earpiece.

In exemplary embodiments, a listener-earpiece may include an attached microphone, where sound received by the attached microphone, is transformed into an audio signal and, where the audio signal is transmitted to the mobile device, where the mobile device, on receiving the transmitted audio signal from the listener-earpiece, processes the audio signal to populate input parameters to the mobile device digital signal processor.

In some embodiments, an earpiece may contain a microphone. This microphone may be used to provide secondary information to the Application to improve its processing. For example, the microphone may provide secondary inputs for ambient sound, which may be utilized for characterizing ambient noise. The earpiece contained microphone may also be used to recognize speech from the user, e.g., to adjust the speaker's volume in comparison to the speech of a targeted speaker or to otherwise adjust a gain parameter. In some embodiments, the earpiece may also include computation capability for transmission of status report information from the earpiece to the mobile-device to report status, e.g., battery state. In exemplary embodiments, a transmitted audio signal from the earpiece microphone may be used to create a supplemental noise profile, which represents the ambient noise that is reaching a listener's ear. This supplemental noise profile may be used to populate parameters for DSP.

In exemplary embodiments, a wireless earpiece can smoothly transition between various functions provided by a paired mobile device in addition to receiving the processed audio, including receiving and processing music or electronic audio, and utilizing the listener-earpiece as a telephone receiver. Different modes of use may include, e.g., telephone calls, typically conveyed over the Bluetooth Hands Free Protocol, listening to music, typically conveyed over Bluetooth via the A2DP, and remote microphone mode where the incoming audio is sourced by the primary microphone of the smartphone.

In exemplary embodiments, digital processors, which are contained in the wireless earpiece, can receive and process control and profile information from a paired mobile device to populate input parameters to the wireless earpiece's digital processor, acquire and transmit status and state information, and perform local digital signal processing to enhance the produced sound derived from received audio. In some embodiments an earpiece may include receipt and computational capabilities for receiving and instantiating control and profile information from the mobile-device.

In some embodiments, the systems and methods of the present disclosure may utilize an external microphone, e.g., via wired or wireless microphone extenders. In example embodiments, a wireless microphone and wireless transmission device may be a 2.4 gHz device, whose signal can be received by the dongle, to minimize latency.

Exemplary embodiments may utilize microphone extenders, e.g., external wired microphones that plug into the microphone jack of the mobile-device; The extender mic may be pins that go outside clothes. The microphone wire may be hidden under clothing but has the connection pins of the microphone pierce the clothing and connect to a small (lapel pin sized) microphone. This microphone extender may hold one or two microphones or even an array of microphones. The microphone extender may also have a small wind buffer cover.

In exemplary embodiments, the systems and methods of the present disclosure may optionally include an audio integration unit that connects typically via a wired connection such as the Dock connector or USB but may be connected wirelessly, for example via Bluetooth or Wi-Fi. The audio integration unit may include one or more of the following:
Input jacks for stereo audio that may be sourced by a music player, a computer, a TV, etc.
Specialized circuitry for hearing assistance including: T-coils, Direct Audio Input (DAD, and/or specific FM signals
One or more microphones
Wired or wireless connections to a land line phone. Wireless may be, for example, a DECT wireless connection.

The received sound may be pre-processed either by being pre-amplified or modified to reduce certain types of noise. The noise reduction in the external mike may handle noise that may be consistent and may be reduced, without danger of adversely affecting the signal to noise ratio, e.g., wind.

To directly accommodate these electrical sources of audio sound, an optional element of the preferred embodiment of the invention is an audio integration accessory (AIA). The purpose of this AIA is to support the electrical source and can also include one or more microphones to improve upon the sound that is available from the mobile device microphones. In particular the microphones can provide directional pickup and offer higher noise suppression.

When the AIA included multiple microphones, the signal processing can select the mic that's closest to the sound as the primary and the others as secondary, use the mics in pairs for directionality both in determining where the sound is coming from and picking up sound only where it's coming from, or use a mic farther away from the target for noise cancellation (may be applied differentially with a closer mic to facilitate filtering noise).

In example embodiments, a history of a designated set of parameter settings, state variables, and/or Profiles may be saved to storage on the Cloud, such that the history of use can be examined and that previous settings can be restored.

Through the Cloud connectivity offered in the multipurpose programmable operating system of the Mobile Computing Device, control settings, Profiles, and at times audio input and output, are stored in the Cloud. Beyond the standard use of such data for backup and restore, this data would be used for accurate usage data. By saving all changes to settings, Profiles, speech-to-noise levels, duration of use, and even sample recorded sound to the Cloud, a continuous record of a User's hearing activity would be recorded. Applications may then be applied to that record to analyze a User's hearing situation and provide a warning if hearing is deteriorating inappropriately or if a medical condition is recognized. This record may be especially valuable to hearing professionals to help in understanding a deteriorating hearing situation.

In addition to utilizing the Internet to access Cloud storage, the embodiment may interface with other internet services. In particular, since the User would be using the embodiment continuously for hearing assistance, there would be an “always on” audio connection to the Internet. This would be useful to push audio information to a User, specifically advertisements and marketing messages.

Some embodiments may utilize a cloud implementation for back-up and restore purposes. This may be implemented such that, on a schedule or by command, all data or specified data, as well as system settings and parameters, which may be stored locally on the mobile-device, may be backed up to the cloud. This backed-up data may be used for a number of purposes such as re-setting a mobile-device that has lost information or to transition from one mobile-device (e.g., one old mobile-device) to another mobile device (e.g., the newly purchased mobile-device.)

Example embodiments may also utilize a cloud implementation for record keeping. For example, this may be implemented by saving all changes to settings, profiles, speech-to-noise levels, duration of use and even sample recorded sound to the cloud to produce a continuous record of a user's hearing activity. Applications may then be applied to the record to analyze a user's hearing situation and provide a warning if hearing is deteriorating inappropriately or if medical condition is recognized. This record may be especially valuable to hearing professionals to help in understanding a deteriorating hearing situation.

As hearing loss can involve a medical condition, exemplary embodiments of the systems and methods disclosed herein may include an optional feature where all hearing settings are retained and stored in the cloud. This stored information can then be utilized to analyze a user's hearing, for example, changes in a user's hearing such as to help determine whether it is time for a user to consult an audiologist or ENT. Also the recording information may be of value to an audiologist or ENT to understand the progression of a user's hearing loss.

In some embodiments, the cloud connection may be utilized for various purposes, including, but not limited to, providing backup, storing information for an accessible permanent record, receiving software/firmware updates, utilizing speech recognition capabilities available in the cloud and the like.

In exemplary embodiments, the digital processor may be trained to recognize a specific keyword and when the keyword is recognized processes the following speech as a command that changes the state of a parameter or execute an action. This can be implemented by providing, through the application, an ability of the mobile-device to hear and recognize oneword. This keyword may be specifically designed to be recognized in all sound environments, including noisy environments, or low gain speech environment. This keyword can be used as a signal to the mobile-device that an audio command is to follow. In effect, users may be able to use the keyword to speak a “name” for their mobile-device. The mobile-device may then discern and discriminate between commands directed at it and normal conversations. This innovation may then enable true hands free use of the mobile-device as there may be no need for a manual action to signal initiation of command processing, which is currently the state of the art.

In example embodiments the systems and methods of the present disclosure may be configured for recognizing speech as command/input by the earpiece, e.g., based on use of a spoken phone id. Speech which is identified as command/input can be passed to an application running on the mobile-device for processing the follow-on audio conversation with that application.

1. A hearing assistance system comprising:
a mobile platform executing a mobile platform operating system with a programmable microprocessor; and
a hearing assistance software application having executable code for executing on the mobile platform using the mobile platform operating system and programmable microprocessor to process sound input received by the mobile platform to improve clarity of received speech.

2. The system of claim 1, wherein the mobile platform implements a Bluetooth-based transmission protocol for achieving transmission of the sound input, after processing thereof to improve the clarity of received speech, with a transmission latency of less than 20 ms.

3. The system of claim 1, wherein the processing the received sound input is achieved with a processing latency of less than 20 ms.

4. The system of claim 1, wherein the mobile platform operating system is one of an IOS operating system, an Android operating system or a Windows operating system.

5. The system of claim 1, wherein the improving the clarity of received speech includes increasing a speech to noise ratio for the received sound input.

6. The system of claim 1, wherein the processing the received sound input includes pre-processing the received sound input to at least one of (i) amplify the received sound input or (ii) suppress consistent noise.

7. The system of claim 1, wherein the processing the received sound input includes utilizing digital signal processor (DSP) components of the microprocessor to process the received sound input.

8. The system of claim 7, wherein the processing the received sound input includes using DSP blocks for low latency signal processing.

9. The system of claim 1, wherein the processing the received sound input includes a primary processing in near-real time and a secondary processing of the received sound input to set or adjust one or more parameters applied during the primary processing.

10. The system of claim 9, wherein primary processing is achieved with a processing latency of less than 25 ms.

11. The system of claim 9, wherein the secondary processing includes a dynamic adaptive control to automatically set or adjust the one or more parameters based on detected changes in a noise environment or in detected speech.

12. The system of claim 11, wherein the one or more parameters includes a frequency equalization profile for a targeted individual, group of individuals or sound type.

13. The system of claim 1, wherein the processing the received sound input includes applying speech detection to detect speech.

14. The system of claim 13, wherein the speech detection includes a combination of energy based speech detection and voiced speech detection.

15. The system of claim 14, wherein the energy based speech detection is used to determine start and end points of speech and the voiced speech detection is used to determine whether detected sound is voiced speech.

16. The system of claim 14, wherein the voiced speech detection is a pitch based voiced speech detection.

17. The system of claim 14, wherein the voiced speech detection is a spectral pattern based voiced speech detection.

18. The system of claim 14, wherein the energy based speech detection includes spectral band energy based speech detection.

19. The system of claim 14, wherein the voiced speech detection is used to detect non-voiced sound for use as a noise reference.

20. The system of claim 13, wherein the processing the received sound input further includes applying one or more algorithms to enhance speech or reduce noise when speech is detected.

21. The system of claim 13, wherein the processing the received sound input further includes applying noise reduction or noise suppression when speech is not detected.

22. The system of claim 1, wherein the processing the received sound input includes applying at least one of dynamic range compression, frequency based amplification or format boosting.

23. The system of claim 1, wherein the processing the received sound input includes applying one or more noise reduction algorithms.

24. The system of claim 1, wherein the processing the received sound input includes applying frequency equalization profile to improve targeted speech.

25. The system of claim 24, wherein the frequency equalization profile is selected by a user from a plurality of stored profiles.

26. The system of claim 25, wherein the frequency equalization profile is automatically selected from a plurality of stored profiles.

27. The system of claim 24, wherein the frequency equalization profile is a custom profile for a targeted individual, group of individuals or sound type.

28. The system of claim 27, wherein the frequency equalization profile is a custom profile for a targeted gender.

29. The system of claim 1, wherein the processing the received sound input includes applying a frequency transformation.

30. The system of claim 1, further comprising a speaker component in communication with the mobile platform, the speaker component including a speaker for outputting the processed sound input.

31. The system of claim 30, wherein the speaker component is in wireless communication with the mobile platform.

32. The system of claim 30, wherein the speaker component is an earpiece.

33. The system of claim 1, wherein the processing the received sound input includes wireless transmission of the sound input after processing thereof to improve the clarity of received speech, wherein the processing the received sound input including the wireless transmission is achieved with a processing latency of less than 40 ms.

34. The system of claim 1, wherein the mobile platform operating system includes low level routines called by an operating environment including at least one of device drivers or firmware, wherein the processing the received sound input includes utilizing the low level routines to reduce latency.

35. The system of claim 1, wherein the improving speech clarity includes improving targeted speech clarity.

36. The system of claim 1, wherein the processing the received sound input includes suppression of noise in a selected range of frequencies and transformation of detected speech to the suppressed frequency range.

37. The system of claim 1, wherein the processing the received sound input includes selecting a sound input from a plurality of stored recordings and processing the selected sound input.

38. The system of claim 1, further comprising a database for storing a plurality of frequency equalization profiles based on targeted individuals, groups of individuals or sound types.

39. The system of claim 1, further comprising a database for storing a plurality of sets of one or more parameters for the processing the received sound input to improve the clarity of received speech.

40. The system of claim 1, wherein the processing the received sound input includes improving speech-to-noise ratio by at least one of lowering a gain of a non-speech range of frequencies and increasing a gain of speech range of frequencies.

41. The system of claim 1, wherein the processing the received sound input includes circumventing an operating system interface by including speech and sound processing directly using digital signal processor (DSP) blocks or low level routines thereby reducing latency.
